(19) United States
(12) Patent Application Publication
(10) Pub. No.: US 2026/0221879 A1
(43) Pub. Date: Jul. 30, 2026

(54) CONTROL CIRCUIT AND CONTROL METHOD FOR SWITCHED-MODE POWER SUPPLY, AND CHIP

(71) Applicant: Zhuhai Nanxin Semiconductor Technology Co., Ltd., Zhuhai City (CN)

(72) Inventors: Zhi WEI, Zhuhai City (CN); Pan LUO, Zhuhai City (CN)

(21) Appl. No.: 19/458,675

(22) Filed: Jan. 23, 2026

(30) Foreign Application Priority Data
Jan. 24, 2025 (CN) 202510116924.6

(51) Int. Cl. H02M 3/158; H02M 1/00

(52) U.S. Cl. CPC H02M 3/158; H02M 1/0009

(57) ABSTRACT

The present disclosure relates to the technical field of switching power supplies, and in particular, relates to a control circuit and control method for a switched-mode power supply, and a chip. A compensation current selection circuit and a current compensation circuit are both configured to adaptively compensate a loop current in different operating modes, to acquire a loop control circuit. Based on the compensation current selection circuit and the current compensation circuit in the present application, the switched-mode power supply may be enabled to adaptively adjust the output loop control current during mode switching, and further perform loop control on the switched-mode power supply based on the loop control current, such that the central value of the output voltage remains substantially consistent before and after the mode switching. This prevents the generation of large ripples in the output voltage and ensures the operational stability of the switched-mode power supply.

### CROSS REFERENCE TO THE RELATED APPLICATIONS

This application is based upon and claims priority to Chinese Patent Application No. 202510116924.6, filed on Jan. 24, 2025, the entire contents of which are incorporated herein by reference.

### TECHNICAL FIELD

The present disclosure relates to the technical field of switching power supplies, and in particular, relates to a control circuit and control method for a switched-mode power supply, and a chip.

### BACKGROUND

The operating modes of a switched-mode power supply may be classified into a forced continuous conduction mode (FCCM) and a discontinuous conduction mode (DCM). The continuous conduction mode may reduce the ripple of the switched-mode power supply and is suitable for heavy load conditions. The discontinuous conduction mode is typically applied under light load conditions to improve the conversion efficiency of the switched-mode power supply at light loads; however, the ripple increases as the switching period is extended.

Under light load conditions, in a case where forced switching occurs between the continuous conduction mode and the discontinuous conduction mode, a significant switching ripple may be generated on the output voltage of the switched-mode power supply due to different operating points of the two modes. Alternatively, in a case where the input voltage of the switched-mode power supply changes, switching between operating modes may also be triggered, which similarly results in a large switching ripple on the output voltage. This ripple may cause the output voltage of the switched-mode power supply to fluctuate, which adversely affects the stability of the output voltage and thus degrades the overall performance of the switched-mode power supply.

### SUMMARY

Embodiments of the present disclosure provide a control circuit and control method for a switched-mode power supply, and a chip, to solve the technical problem that the output voltage at the output terminal of the switched-mode power supply during mode switching in the related art has poor reliability.

In a first aspect, some embodiments of the present disclosure provide a control circuit for a switched-mode power supply, the switched-mode power supply including a first transistor, a second transistor, and a first inductor; wherein the switched-mode power supply is a buck converter, a boost converter, or a buck-boost converter based on different connection relationships of the first transistor, the second transistor, and the first inductor; an input terminal of the switched-mode power supply is configured to receive an input voltage, and an output terminal of the switched-mode power supply is configured to output an output voltage.

The control circuit includes a current sampling circuit, an inductor current ripple sampling circuit, a compensation current selection circuit, a current compensation circuit, a first resistor, a second resistor, a first comparator, an inductor current sampling circuit, and a logic control circuit.

The current sampling circuit is configured to sample a voltage value of the output voltage at the output terminal of the switched-mode power supply, and acquire a current value of a loop compensation current based on the voltage value of the output voltage.

The inductor current ripple sampling circuit is configured to sample a voltage value of the input voltage and the voltage value of the output voltage, calculate an inductor current ripple value of the switched-mode power supply based on the voltage value of the input voltage and the voltage value of the output voltage, and generate a voltage value of a half-ripple control current based on the inductor current ripple value.

The compensation current selection circuit is configured to determine a target control current based on the loop compensation current and the half-ripple control current.

The current compensation circuit is configured to, in a case where the switched-mode power supply operates in a peak current control mode, add the current value of the half-ripple control current and a current value of the target control current to acquire a current value of a loop control current; or in a case where the switched-mode power supply operates in a valley current control mode, acquire a current value of a loop control current based on a difference value between a current value of the target control current and the current value of the half-ripple control current.

The inductor current sampling circuit is configured to sample an inductor current in a branch where the first inductor is disposed, and transmit the inductor current to a non-inverting input terminal of the first comparator via the first resistor, wherein the inductor current passes through the first resistor to generate a first voltage.

The second resistor is configured to transmit the loop control current to an inverting input terminal of the first comparator, wherein the loop control current passes through the second resistor to generate a second voltage value.

The first comparator is configured to compare a voltage value of the first voltage with a voltage value of the second voltage, and output a first control signal in a case where the voltage value of the first voltage is equal to the voltage value of the second voltage.

The logic control circuit is configured to output a corresponding drive signal based on the first control signal, the drive signal being configured to drive the first transistor and/or the second transistor to turn on or turn off.

In some embodiments, in a case where the switched-mode power supply is a buck converter, the compensation current selection circuit is further configured to receive the current value of the loop compensation current output by the current sampling circuit, and determine one with a greater current value between the loop compensation current and the half-ripple control current as the target control current.

In some embodiments, in a case where the switched-mode power supply is a buck converter, an input terminal of the current sampling circuit is electrically connected to the output terminal of the switched-mode power supply, and an output terminal of the current sampling circuit is electrically connected to a first input terminal of the compensation current selection circuit; and two sampling terminals of the inductor current ripple sampling circuit are respectively electrically connected to the input terminal and the output terminal of the switched-mode power supply, and an output terminal of the inductor current ripple sampling circuit is electrically connected to a second input terminal of the compensation current selection circuit.

An output terminal of the compensation current selection circuit is electrically connected to an input terminal of the current compensation circuit, and an output terminal of the current compensation circuit is electrically connected to the inverting input terminal of the first comparator via the second resistor; a sampling terminal of the inductor current sampling circuit is electrically connected to the branch where the first inductor is disposed, and an output terminal of the inductor current sampling circuit is electrically connected to the non-inverting input terminal of the first comparator via the first resistor; and an output terminal of the first comparator is electrically connected to a first input terminal of the logic control circuit, a first output terminal of the logic control circuit is electrically connected to a control electrode of the first transistor, and a second output terminal of the logic control circuit is electrically connected to a control electrode of the second transistor.

In some embodiments, the control circuit further includes a first timer circuit, wherein the first timer circuit includes a second comparator, a third resistor, and a first capacitor.

In a case where the switched-mode power supply is a buck converter: a first terminal of the third resistor is electrically connected to the input terminal of the switched-mode power supply, a second terminal of the third resistor is electrically connected to a first terminal of the first capacitor, a second terminal of the first capacitor is grounded, the first terminal of the first capacitor is further electrically connected to a non-inverting input terminal of the second comparator, and an output terminal of the second comparator is electrically connected to a second input terminal of the logic control circuit.

The non-inverting input terminal of the second comparator is configured to receive a voltage value of a third voltage at the first terminal of the first capacitor; the inverting input terminal of the second comparator is configured to receive the voltage value of the output voltage in the peak current control mode, or receive a first difference value in the valley current control mode, wherein the first difference value is a voltage difference value between the voltage value of the input voltage and the voltage value of the output voltage; and the second comparator is configured to compare the voltage value of the third voltage with the voltage value of the output voltage and output a first clock signal to the logic control circuit in a case where the voltage value of the third voltage is equal to the voltage value of the output voltage, or compare the voltage value of the third voltage with the first difference value and output the first clock signal to the logic control circuit in a case where the voltage value of the third voltage is equal to the first difference value.

The logic control circuit is configured to, in the peak current control mode, generate a first drive signal based on the first clock signal, the first drive signal being configured to drive the second transistor to turn off; or in the valley current control mode, generate a second drive signal and a third drive signal based on the first clock signal, the second drive signal being configured to drive the first transistor to turn off, and the third drive signal being configured to drive the second transistor to turn on.

In some embodiments, the control circuit further includes: a first timer circuit, wherein the first timer circuit includes a second comparator, a multiplier, and a first capacitor.

In a case where the switched-mode power supply is a buck converter: an input terminal of the multiplier serves as an input terminal of the first timer circuit and is configured to receive the input voltage of the switched-mode power supply, an output terminal of the multiplier is electrically connected to a first terminal of the first capacitor, a second terminal of the first capacitor is grounded, the first terminal of the first capacitor is further electrically connected to a non-inverting input terminal of the second comparator, and an output terminal of the second comparator is electrically connected to a second input terminal of the logic control circuit.

The multiplier is configured to multiply the input voltage by 1/R_{Rcot}, wherein R_{Rcot} is a resistance value of a third resistor.

The non-inverting input terminal of the second comparator is configured to receive a third voltage at the first terminal of the first capacitor, and an inverting input terminal of the second comparator is configured to receive a reference voltage value; wherein in the peak current control mode, the reference voltage value is the voltage value of the output voltage of the switched-mode power supply; or in the valley current control mode, the reference voltage value is a first difference value, the first difference value being a voltage difference value between the voltage value of the input voltage and the voltage value of the output voltage of the switched-mode power supply.

The second comparator is configured to, in the peak current control mode, compare the voltage value of the third voltage with the voltage value of the output voltage of the switched-mode power supply and output a first clock signal in a case where of the voltage value of the third voltage is equal to the voltage value of the output voltage; or in the valley current control mode, compare the voltage value of the third voltage with the first difference value and output the first clock signal in a case where the voltage value of the third voltage is equal to the first difference value.

The logic control circuit is configured to, in the peak current control mode, generate a first drive signal based on the first clock signal, the first drive signal being configured to drive the second transistor to turn off; or in the valley current control mode, generate a second drive signal and a third drive signal based on the first clock signal, the second drive signal being configured to drive the first transistor to turn off, and the third drive signal being configured to drive the second transistor to turn on.

In some embodiments, the control circuit further includes: a second timer circuit, wherein the second timer circuit includes a second capacitor, a fourth resistor, and a third comparator.

In a case where the switched-mode power supply is a buck converter: a first terminal of the second capacitor is electrically connected to the output terminal of the current sampling circuit, a second terminal of the second capacitor is grounded, and the first terminal of the second capacitor is further electrically connected to a non-inverting input terminal of the third comparator; and a first terminal of the fourth resistor is electrically connected to the output terminal of the inductor current ripple sampling circuit, a second terminal of the fourth resistor is grounded, the first terminal of the fourth resistor is further electrically connected to an inverting input terminal of the third comparator, and an output terminal of the third comparator is electrically connected to a third input terminal of the logic control circuit.

The non-inverting input terminal of the third comparator is configured to receive a voltage value of a fourth voltage at the first terminal of the second capacitor, the inverting input terminal of the third comparator is configured to receive a voltage value of a fifth voltage at the first terminal of the fourth resistor, and the third comparator is configured to compare the voltage value of the fourth voltage with the voltage value of the fifth voltage and output a second clock signal to the logic control circuit in a case where the voltage value of the fourth voltage is equal to the voltage value of the fifth voltage.

The logic control circuit is configured to, in the peak current control mode or the valley current control mode, generate a fourth drive signal based on the second clock signal, the fourth drive signal being configured to drive the first transistor to turn on.

In some embodiments, the control circuit further includes a first timer circuit, wherein the first timer circuit includes a second comparator, a third resistor, and a first capacitor.

In a case where the switched-mode power supply is a boost converter: a first terminal of the third resistor is electrically connected the output terminal of the switched-mode power supply to receive the output voltage; a second terminal of the third resistor is electrically connected a first terminal of the first capacitor, a second terminal of the first capacitor is grounded, the first terminal of the first capacitor is further connected to a non-inverting input terminal of the second comparator, and an output terminal of the second comparator is electrically connected a second input terminal of the logic control circuit; the non-inverting input terminal of the second comparator is configured to receive a voltage value of a third voltage at the first terminal of the first capacitor; an inverting input terminal of the second comparator is configured to receive a second difference value in the peak current control mode, the second difference value being a voltage difference value between the voltage value of the output voltage and the voltage value of the input voltage, or receive the input voltage in the valley current control mode; the second comparator is configured to compare the voltage value of the third voltage with the second difference value and output a first clock signal in a case where the voltage value of the third voltage is equal to the second difference value, or compare the voltage value of the third voltage with the voltage value of the input voltage and output the first clock signal to the logic control circuit in a case where the voltage value of the third voltage is equal to the voltage value of the input voltage; and the logic control circuit is configured to, in the peak current control mode, generate the first drive signal based on the first clock signal, the first drive signal being configured to drive the first transistor to turn off; or in the valley current control mode, generate a second drive signal and a third drive signal based on the first clock signal, the second drive signal being configured to drive the second transistor to turn off, and the third drive signal being configured to drive the first transistor to turn on.

In a case where the switched-mode power supply is a buck-boost converter a first terminal of the third resistor is electrically connected to the input terminal and the output terminal of the switched-mode power supply to receive a voltage value of a sixth voltage, the voltage value of the sixth voltage being a sum of the voltage value of the input voltage and the voltage value of the output voltage; a second terminal of the third resistor is electrically connected to a first terminal of the first capacitor, a second terminal of the first capacitor is grounded, the first terminal of the first capacitor is further electrically connected to a non-inverting input terminal of the second comparator, and an output terminal of the second comparator is electrically connected to a second input terminal of the logic control circuit; the non-inverting input terminal of the second comparator is configured to receive a voltage value of a third voltage at the first terminal of the first capacitor; an inverting input terminal of the second comparator is configured to receive the output voltage in the peak current control mode or receive the input voltage in the valley current control mode; and the second comparator is configured to compare the voltage value of the third voltage with the voltage value of the output voltage and output a first clock signal to the logic control circuit in a case where the voltage value of the third voltage is equal to the voltage value of the output voltage, or compare the voltage value of the third voltage with the voltage value of the input voltage and output the first clock signal to the logic control circuit in a case where the voltage value of the third voltage is equal to the voltage value of the input voltage.

In some embodiments, in a case where the switched-mode power supply is a boost converter or a buck-boost converter: the control circuit further includes a first current output circuit electrically connected between the current sampling circuit and the compensation current selection circuit, wherein the first current output circuit is configured to receive the loop compensation current, the input voltage, and the output voltage, generate a first current based on the loop compensation current, the input voltage, and the output voltage, and transmit the first current to the compensation current selection circuit.

The compensation current selection circuit is further configured to receive the first current and the half-ripple control current, and determine one with a greater current value between the first current and the half-ripple control current as the target control current.

In some embodiments, in a case where the switched-mode power supply is a boost converter: an input terminal of the current sampling circuit is electrically connected to the output terminal of the switched-mode power supply, a first input terminal of the first current output circuit is electrically connected to an output terminal of the current sampling circuit, a second input terminal of the first current output circuit is electrically connected to the output terminal of the switched-mode power supply, a third input terminal of the first current output circuit is electrically connected to the input terminal of the switched-mode power supply, and an output terminal of the first current output circuit is electrically connected to a first input terminal of the compensation current selection circuit; and two sampling terminals of the inductor current ripple sampling circuit are respectively electrically connected to the input terminal and the output terminal of the switched-mode power supply, and an output terminal of the inductor current ripple sampling circuit is electrically connected to a second input terminal of the compensation current selection circuit.

An output terminal of the compensation current selection circuit is electrically connected to an input terminal of the current compensation circuit, and an output terminal of the current compensation circuit is electrically connected to the inverting input terminal of the first comparator via the second resistor; a sampling terminal of the inductor current sampling circuit is electrically connected to the branch where the first inductor is disposed, and an output terminal of the inductor current sampling circuit is electrically connected to the non-inverting input terminal of the first comparator via the first resistor; and an output terminal of the first comparator is electrically connected to a first input terminal of the logic control circuit, a first output terminal of the logic control circuit is electrically connected to a control electrode of the first transistor, and a second output terminal of the logic control circuit is electrically connected to a control electrode of the second transistor.

In some embodiments, the first current output circuit is a multiplier, configured to acquire a ratio by dividing the voltage value of the output voltage by the voltage value of the input voltage, and acquire a first current value of the first current by multiplying the ratio by a current value of the loop compensation current.

In some embodiments, in a case where the switched-mode power supply is a buck-boost converter: an input terminal of the current sampling circuit is electrically connected to the output terminal of the switched-mode power supply, a first input terminal of the first current output circuit is electrically connected to an output terminal of the current sampling circuit, a second input terminal of the first current output circuit is electrically connected to the input terminal and the output terminal of the switched-mode power supply, a third input terminal of the first current output circuit is electrically connected to the input terminal of the switched-mode power supply, and an output terminal of the first current output circuit is electrically connected to a first input terminal of the compensation current selection circuit; and two sampling terminals of the inductor current ripple sampling circuit are respectively electrically connected to the input terminal and the output terminal of the switched-mode power supply, and an output terminal of the inductor current ripple sampling circuit is electrically connected to a second input terminal of the compensation current selection circuit.

An output terminal of the compensation current selection circuit is electrically connected to an input terminal of the current compensation circuit, and an output terminal of the current compensation circuit is electrically connected to the inverting input terminal of the first comparator via the second resistor; a sampling terminal of the inductor current sampling circuit is electrically connected to the branch where the first inductor is disposed, and an output terminal of the inductor current sampling circuit is electrically connected to the non-inverting input terminal of the first comparator via the first resistor; and an output terminal of the first comparator is electrically connected to a first input terminal of the logic control circuit, a first output terminal of the logic control circuit is electrically connected to a control electrode of the first transistor, and a second output terminal of the logic control circuit is electrically connected to a control electrode of the second transistor.

In some embodiments, the first current output circuit is a multiplier, configured to acquire a ratio by dividing a sum of the voltage value of the output voltage and the voltage value of the input voltage by the voltage value of the input voltage, and acquire a current value of the first current by multiplying the ratio by a current value of the loop compensation current.

In some embodiments, the control circuit further includes a second timer circuit, wherein the second timer circuit includes a second capacitor, a fourth resistor, and a third comparator.

A first terminal of the second capacitor is electrically connected to the output terminal of the first current output circuit, a second terminal of the second capacitor is grounded, and the first terminal of the second capacitor is electrically connected to a non-inverting input terminal of the third comparator; and a first terminal of the fourth resistor is electrically connected to the output terminal of the inductor current ripple sampling circuit, a second terminal of the fourth resistor is grounded, the first terminal of the fourth resistor is further electrically connected to an inverting input terminal of the third comparator, and an output terminal of the third comparator is electrically connected to a third input terminal of the logic control circuit.

The non-inverting input terminal of the third comparator is configured to receive a fourth voltage on the second capacitor, the inverting input terminal of the third comparator is configured to receive a voltage value of a fifth voltage on the fourth resistor, and the third comparator is configured to compare the voltage value of the fourth voltage with the voltage value of the fifth voltage and output a second clock signal to the logic control circuit in a case where the voltage value of the fourth voltage is equal to the voltage value of the fifth voltage.

In some embodiments, the current sampling circuit includes a voltage divider circuit, an error amplifier, and a transconductance amplifier.

A sampling terminal of the voltage divider circuit is electrically connected to the output terminal of the switched-mode power supply, an output terminal of the voltage divider circuit is electrically connected an inverting input terminal of the error amplifier, and the voltage divider circuit is configured to divide the output voltage of the switched-mode power supply to acquire a first divided voltage; the inverting input terminal of the error amplifier is configured to receive the first divided voltage from the voltage divider circuit, and a non-inverting input terminal of the error amplifier is configured to receive a reference voltage value; and the error amplifier is configured to calculate an error voltage value between the voltage value of the first divided voltage and the reference voltage value, and amplify the error voltage value to acquire a voltage value of a loop compensation voltage.

An output terminal of the error amplifier is electrically connected to an input terminal of the transconductance amplifier, and the transconductance amplifier is configured to obtain a current value of the loop compensation current based on the voltage value of the loop compensation voltage.

In some embodiments, the voltage divider circuit includes a fifth resistor and a sixth resistor, wherein a first terminal of the fifth resistor is the sampling terminal of the voltage divider circuit, a second terminal of the fifth resistor is electrically connected to a first terminal of the sixth resistor, and a second terminal of the sixth resistor is grounded, and the first terminal of the sixth resistor serves as the output terminal of the voltage divider circuit and is configured to output the first divided voltage.

In some embodiments, the current sampling circuit further includes a seventh resistor and a third capacitor; wherein the output terminal of the error amplifier is electrically connected to a first terminal of the seventh resistor, a second terminal of the seventh resistor is electrically connected to a first terminal of the third capacitor, and a second terminal of the third capacitor is grounded.

In some embodiments, the current compensation circuit includes an adder, a subtractor, and a selection switch; wherein two input terminals of the adder are respectively electrically connected to the output terminal of the inductor current ripple sampling circuit and an output terminal of the compensation current selection circuit, an output terminal of the adder is electrically connected to the selection switch, two input terminals of the subtractor are respectively electrically connected to the output terminal of the inductor current ripple sampling circuit and the output terminal of the compensation current selection circuit, and an output terminal of the subtractor is electrically connected to the selection switch.

The adder is configured to, in the peak current control mode, add a current value of the half-ripple control current and a current value of the target control current to acquire the current value of the loop control current, and generate the loop control current.

The subtractor is configured to, in the valley current control mode, subtract the current value of the half-ripple control current from the current value of the target control current to acquire the current value of the loop control current, and generate the loop control current.

The selection switch is configured to, in the peak current control mode, select to be electrically connected to the output terminal of the adder to output the loop control current generated by the adder to the second resistor; or in the valley current control mode, select to be electrically connected to the output terminal of the subtractor to output the loop control current generated by the subtractor to the second resistor.

In some embodiments, the inductor current ripple sampling circuit is further configured to acquire an inductance value of the first inductor and a switching frequency of the switched-mode power supply.

In a case where the switched-mode power supply is a buck converter, the inductor current ripple sampling circuit is further configured to calculate the inductor current ripple value of the switched-mode power supply according to the following formula:

$$I P P = \frac{( Vin - Vout ) \times Vout}{Vin} \times \frac{1}{{L}_{L} \times Fsw} \times \frac{{R}_{Ri}}{{R}_{Rsns}} ;$$

In a case where the switched-mode power supply is a boost converter, the inductor current ripple sampling circuit is further configured to calculate the inductor current ripple value of the switched-mode power supply according to the following formula:

$$I P P = \frac{( Vout - Vin ) \times Vin}{Vout} \times \frac{1}{{L}_{L} \times Fsw} \times \frac{{R}_{Ri}}{{R}_{Rsns}}$$

Wherein Ipp represents the inductor current ripple value, Vin represents a voltage value of the input voltage of the switched-mode power supply, Vout represents the voltage value of the output voltage of the switched-mode power supply, L_{L} represents an inductance value of the first inductor, Fsw represents a switching frequency of the switched-mode power supply, R_{Ri} represents a resistance value of the first resistor, and R_{Rsns} represents a resistance value of the second resistor.

In some embodiments, the logic control circuit is configured to, in the peak current control mode, output a fifth drive signal and a sixth drive signal based on the first control signal, wherein the drive signal includes the fifth drive signal and the sixth drive signal, the fifth drive signal is configured to drive the first transistor to turn off, and the sixth drive signal is configured to drive the second transistor to turn on.

Alternatively, the logic control circuit is configured to, in the valley current control mode, output a seventh drive signal based on the first control signal, wherein the seventh drive signal is the drive signal, and the seventh drive signal is configured to drive the second transistor to turn off.

In a second aspect, some embodiments of the present disclosure further provide a control method for a switched-mode power supply, applied to the control circuit as described above. In a case where the switched-mode power supply operates in a constant on-time valley current control mode, the control method includes:
detecting whether a second clock signal has been received, and outputting a fourth drive signal to a first transistor in response to detecting that the second clock signal has been received, wherein the fourth drive signal is configured to drive the first transistor to turn on;
detecting whether a first clock signal has been received, and outputting a second drive signal to the first transistor and outputting a third drive signal to a second transistor in response to detecting that the first clock signal has been received, wherein the second drive signal is configured to drive the first transistor to turn off, and the third drive signal is configured to drive the second transistor to turn on; and
detecting whether a first control signal has been received, and outputting a seventh drive signal to the second transistor in response to detecting that the first control signal has been received, wherein the seventh drive signal is configured to drive the second transistor to turn off.

In some embodiments, upon turning off the second transistor, the control method further includes: determining whether the switched-mode power supply operates in a discontinuous conduction mode, monitoring whether the second clock signal has been received in response to determining that the switched-mode power supply operates in the discontinuous conduction mode, and outputting an eighth drive signal in response to detecting that the second clock signal has not been received, wherein the eighth drive signal is configured to drive the first transistor to turn on.

In a third aspect, some embodiments of the present disclosure further provide a control method for a switched-mode power supply, applied to the control circuit as described above. In a case where the switched-mode power supply operates in a constant off-time peak current control mode, the control method includes:
detecting whether a second clock signal has been received, and outputting a fourth drive signal to a first transistor in response to detecting that the second clock signal has been received, wherein the fourth drive signal is configured to drive the first transistor to turn on;
detecting whether a first control signal has been received, and outputting a fifth drive signal to the first transistor and simultaneously outputting a sixth drive signal to a second transistor in response to detecting that the first control signal has been received, wherein the fifth drive signal is configured to drive the first transistor to turn off, and the sixth drive signal is configured to drive the second transistor to turn on; and
detecting whether a first clock signal has been received, and outputting a first drive signal to the second transistor in response to detecting that the first clock signal has been received, wherein the first drive signal is configured to drive the second transistor to turn off.

In some embodiments, upon turning off the second transistor, the control method further includes: determining whether the switched-mode power supply operates in a discontinuous conduction mode, monitoring whether the second clock signal has been received in response to determining that the switched-mode power supply operates in the discontinuous conduction mode, and outputting an eighth drive signal in response to detecting that the second clock signal has not been received, wherein the eighth drive signal is configured to drive the first transistor to turn on.

In a fourth aspect, some embodiments of the present disclosure further provide a chip. The chip includes the control circuit for a switched-mode power supply as described above.

In a fifth aspect, some embodiments of the present disclosure further provide an electronic device. The electronic device includes the control circuit for a switched-mode power supply as described above; or the electronic device includes the chip as described above.

The control circuit for the switched-mode power supply according to the first aspect includes a current sampling circuit, an inductor current ripple sampling circuit, a compensation current selection circuit, a current compensation circuit, a first resistor, a second resistor, a first comparator, an inductor current sampling circuit, and a logic control circuit. The current sampling circuit is configured to sample a voltage value of an output voltage at an output terminal of the switched-mode power supply, and acquire a current value of a loop compensation current based on the voltage value of the output voltage. The inductor current ripple sampling circuit is configured to sample a voltage value of an input voltage and the voltage value of the output voltage, calculate an inductor current ripple value of the switched-mode power supply based on the voltage value of the input voltage and the voltage value of the output voltage, and generate a current value of a half-ripple control current based on the inductor current ripple value. The compensation current selection circuit is configured to determine one with a greater current value between the loop compensation current and the half-ripple control current as a target control current. The current compensation circuit is configured to: in a case where the switched-mode power supply operates in a peak current control mode, output the current value of the half-ripple control current to be superimposed on the current value of the target control current, to acquire a current value of a loop control current; or in a case where the switched-mode power supply operates in a valley current control mode, acquire a current value of a loop control current based on a difference value between the current value of the target control current and the current value of the half-ripple control current. The inductor current sampling circuit is configured to sample a current value of an inductor current in a branch where a first inductor is disposed, and convert the inductor current into a first voltage via the first resistor. The second resistor is configured to convert the loop control current into a second voltage. The first comparator is configured to output a first control signal in a case where the voltage value of the first voltage is equal to the voltage value of the second voltage. The logic control circuit is configured to output a first drive signal and a second drive signal based on the first control signal, wherein the first drive signal is configured to drive a first transistor to turn on, and the second drive signal is configured to drive a second transistor to turn off. It is apparent that, based on the compensation current selection circuit and the current compensation circuit in the present application, the switched-mode power supply may be enabled to adaptively adjust the output loop control current Iloop during mode switching, and further perform loop control on the switched-mode power supply based on the loop control current, such that the central value of the output voltage remains substantially consistent before and after the mode switching. This prevents the generation of large ripples in the output voltage and ensures the operational stability of the switched-mode power supply.

For details about the beneficial effects achieved by the method according to the above aspects and the embodiments of the above aspects, reference may be made to the beneficial effects achieved by the first aspect or any embodiment of the first aspect, which are not described herein any further.

### BRIEF DESCRIPTION OF THE DRAWINGS

For clearer descriptions of the technical solutions according to the embodiments of the present disclosure or in the related art, drawings that are to be referred for description of the embodiments or the prior art are briefly described hereinafter. Apparently, the drawings described hereinafter merely illustrate some embodiments of the present disclosure. Persons of ordinary skill in the art may also derive other embodiments based on the drawings described herein.

FIG. 1 is a schematic circuit diagram of a switched-mode power supply in the related art.

FIG. 2 is a schematic structural diagram of a control circuit for a switched-mode power supply according to an embodiment of the present disclosure.

FIG. 3 is a first schematic structural diagram of a first timer circuit according to an embodiment of the present disclosure.

FIG. 4 is a second schematic structural diagram of the first timer circuit according to an embodiment of the present disclosure.

FIG. 5 is a schematic structural diagram of a second timer circuit according to an embodiment of the present disclosure.

FIG. 6 is a schematic structural diagram of a current sampling circuit according to an embodiment of the present disclosure.

FIG. 7 is a schematic structural diagram of a current compensation circuit according to an embodiment of the present disclosure.

FIG. 8 is a schematic diagram of the overall structure of the control circuit for the switched-mode power supply according to an embodiment of the present disclosure.

FIG. 9 is a flowchart of operations in a constant on-time valley current control mode according to an embodiment of the present disclosure.

FIG. 10 is a flowchart of operations in a constant off-time peak current control mode according to an embodiment of the present disclosure.

FIG. 11 is a schematic diagram of operating waveforms of an inductor current in a forced continuous conduction mode and a pulse frequency modulation (PFM) mode according to an embodiment of the present disclosure.

FIG. 12 is a schematic diagram of operating waveforms of the control circuit according to an embodiment of the present disclosure.

FIG. 13 is a first flowchart of a control method according to an embodiment of the present disclosure.

FIG. 14 is a second flowchart of the control method according to an embodiment of the present disclosure.

FIG. 15 is a schematic structural diagram of a control circuit for a boost converter according to an embodiment of the present disclosure.

FIG. 16 is a flowchart of operations for the boost converter in the constant on-time valley current control mode according to an embodiment of the present disclosure.

FIG. 17 is a flowchart of operations for the boost converter in the constant off-time peak current control mode according to an embodiment of the present disclosure.

FIG. 18 is a schematic structural diagram of a control circuit for a buck-boost converter according to an embodiment of the present disclosure.

### DETAILED DESCRIPTION OF THE EMBODIMENTS

In the present disclosure, the term “at least one” refers to one or more than one, and the term “a plurality of” refers to two or more than two. The term “and/or” is merely an association relationship for describing associated objects, which represents that there may exist three types of relationships. For example, the phrase “A and/or B” means (A), (B), or (A and B), wherein A and B may be single or plural. In addition, the symbol “/” generally represents an “or” relationship between associated objects before and after the symbol. The expression “at least one of the following” or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms “first,” “second,” and the like are merely for the illustration purpose, and shall not be construed as indicating or implying a relative importance.

In the description of the present disclosure, it should be understood that the terms “central,” “transversal,” “longitudinal,” “upper,” “lower,” “left,” “right,” “front,” “rear,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms “connected,” “coupled,” and derivatives forms thereof shall be understood in a broad sense. For example, the terms “connected,” “coupled,” and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is turned on, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

The transistors according to the embodiments of the present disclosure are all three-terminal transistors. For example, each of the transistors has a control terminal, a first terminal, and a second terminal. The transistors may be bipolar transistors or field-effect transistors. For example, in a case where the transistor is a bipolar transistor, the control terminal of the transistor refers to a base of the bipolar transistor, the first terminal refers to a collector or an emitter of the bipolar transistor, and the second terminal refers to an emitter or a collector, respectively; or in a case where the transistor is a field-effect transistor, the control terminal of the transistor refers to a gate of the field-effect transistor, the first terminal of the transistor refers to a drain or a source of the field-effect transistor, and the second terminal of the transistor is a source or drain of the field-effect switching transistor, respectively.

The operating modes of a switched-mode power supply may be classified into a forced continuous conduction mode and a discontinuous conduction mode. The continuous conduction mode may reduce the ripple of the switched-mode power supply and is suitable for heavy load conditions. The discontinuous conduction mode is typically applied under light load conditions to improve the conversion efficiency of the switched-mode power supply at light loads; however, the ripple increases as the switching period is extended. Under light load conditions, in a case where forced switching occurs between the continuous conduction mode and the discontinuous conduction mode, an issue arises because operating points of the two modes are different. This operating point primarily refers to the operating point of a control loop of the power supply, which may specifically be a loop compensation voltage Vcmp or a loop compensation current Icmp. The issue is that, in a case where the switched-mode power supply undergoes switching in the operating mode, a large switching ripple is generated on an output voltage at an output terminal of the power supply. This ripple may cause the output voltage to fluctuate, which adversely affects the stability of the output voltage and thus degrades the overall performance of the switched-mode power supply. Alternatively, in another application scenario, a change in an input voltage of the switched-mode power supply may also trigger adaptive switching in the operating mode, which similarly results in a large switching ripple on the output voltage and degrades the performance of the switched-mode power supply.

The control of a switched-mode power supply is often implemented using a pulse frequency modulation (PFM), which is a conversion method typically used in DC-DC converters to improve efficiency at light loads. In the field of switched-mode power supplies, the PFM is also known as a “power-saving” mode. A switched-mode power supply operating in the power-saving mode uses a PFM mode under light load current conditions and a pulse-width modulation (PWM) mode under heavier load current conditions. This operational scheme allows the converter to maintain a very high efficiency over a wide range of output currents. The forced continuous conduction mode and the discontinuous current mode are two operating modes under the pulse frequency modulation scheme. In a case where the loop of the switched-mode power supply operates under the same load but in different control modes, different circuit operating points are produced. That is, the loop compensation voltage VCOMP is different under the same load. In a case where forced mode switching occurs or the input voltage experiences a transient, the loop of the switched-mode power supply is re-adjusted. Due to the bandwidth limitation of the loop of the switched-mode power supply, this adjustment takes time, causing the output voltage to fluctuate. The magnitude of the voltage fluctuation depends on the difference between the two operating points. The larger the difference, the greater the voltage fluctuation, and thus the larger the resulting ripple.

To overcome the defects in the related art, the present disclosure analyzes that the key factor causing the ripple is that when forced mode switching occurs under the same load, or when a change in the input voltage causes a mode change, the loop needs to be re-stabilized to a new operating point, which leads to fluctuations in the output voltage. The present disclosure addresses this issue by setting the operating points of the two modes to be the same, thereby ensuring the stability of the output voltage during forced mode switching or input voltage transients.

For practice of the inventive concept, the control circuit according to the present disclosure, based on the control circuits according to the related arts, is designed with an inductor current ripple sampling circuit, a compensation current selection circuit, and a current compensation circuit. The inductor current ripple sampling circuit is configured to sample a voltage value of an input voltage and a voltage value of an output voltage, calculate an inductor current ripple value of the switched-mode power supply based on the voltage value of the input voltage and the voltage value of the output voltage, and generate a current value of a half-ripple control current based on the inductor current ripple value. The current sampling circuit is configured to sample the voltage value of the output voltage at the output terminal of the switched-mode power supply, and acquire a current value of a loop compensation current based on the voltage value of the output voltage. The compensation current selection circuit is configured to determine one with a greater current value between the loop compensation current and the half-ripple control current as a target control current. Then, the current compensation circuit is configured to, in a case where the switched-mode power supply operates in a peak current control mode, output the loop control current which current value is equaled to a sum of the current value of the half-ripple control current and the current value of the target control current; or in a case where the switched-mode power supply operates in a valley current control mode, acquire the loop control current based on a difference value between the current value of the target control current and the current value of the half-ripple control current. This ensures that the resulting current value of the loop control current is always maintained within a predetermined threshold range. That is, the peak current value of the loop control current is prevented from becoming excessively high, while the valley current value of the loop control current is also prevented from dropping too low. As a result, by controlling the switched-mode power supply based on the loop control current and the sampled inductor current from the loop, it may be ensured that the central value of the output voltage remains substantially consistent before and after mode switching. This prevents the generation of large ripples in the output voltage and ensures the operational stability of the switched-mode power supply.

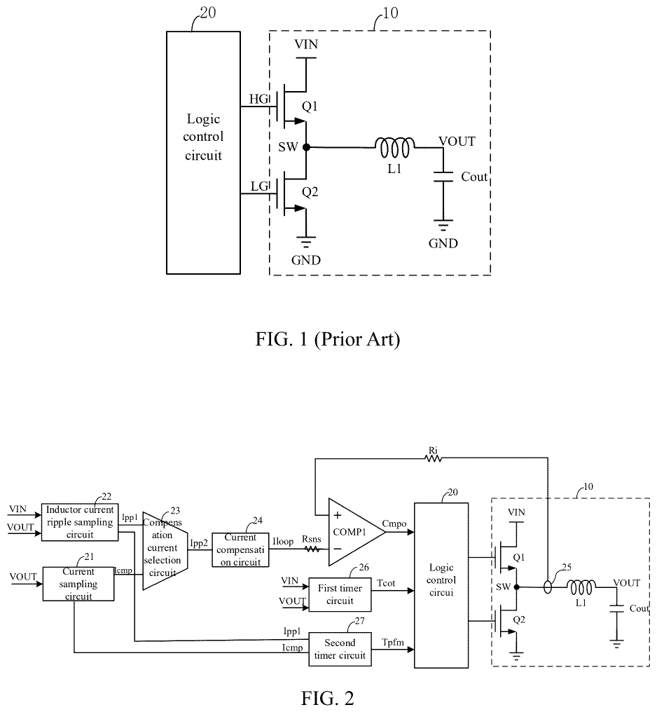

For clearer descriptions of the structure and operating principle of the control circuit for the switched-mode power supply according to the present disclosure, a commonly used circuit structure for a switched-mode power supply is provided. FIG. 1 is a schematic circuit diagram of a switched-mode power supply in the related art. It should be noted that the circuit structure of the switched-mode power supply 10 illustrated in FIG. 1 is merely one common type in the art and does not imply that the control circuit according to the present disclosure is only applied to this specific type. In practice, the control circuit of the present disclosure may be applied to the switched-mode power supply circuit 10 illustrated in FIG. 1 as well as variations thereof. For example, the switched-mode power supply circuit 10 may be any one of a boost converter, a buck converter, or a buck-boost converter.

Referring to FIG. 1, the switched-mode power supply 10 is configured as a buck converter. The switched-mode power supply 10 includes a first transistor Q1, a second transistor Q2, and a first inductor L1. A first terminal of the first transistor Q1 serves as an input terminal of the switched-mode power supply. The input terminal of the switched-mode power supply is configured to receive an input voltage VIN. A second terminal of the first transistor Q1 is electrically connected to a first terminal of the second transistor Q2 at a connection node SW. A second terminal of the second transistor Q2 is grounded (that is, connected to a GND terminal). The second terminal of the first transistor Q1 is further electrically connected to a first terminal of the first inductor L1. A second terminal of the first inductor L1 serves as an output terminal of the switched-mode power supply. The output terminal of the switched-mode power supply is configured to output an output voltage VOUT.

Based on the switched-mode power supply circuit illustrated in FIG. 1, during a switching cycle, a logic control circuit 20 is electrically connected to control electrodes of the first transistor Q1 and the second transistor Q2, respectively. The logic control circuit 20 is configured to output a corresponding drive signal to drive the first transistor Q1 to turn on or turn off and drive the second transistor Q2 to turn on or turn off, such that the switched-mode power supply 10 is controlled to switch between charging and discharging states. Specifically, during a switching cycle, the logic control circuit 20 first controls the first transistor Q1 to turn on while controlling the second transistor Q2 to turn off. This allows an input voltage VIN to charge the first inductor L1, thereby enabling the first inductor L1 to store energy. In a case where the first inductor L1 has completed energy storage, the logic control circuit 20 controls the first transistor Q1 to turn off and the second transistor Q2 to turn on. Once the second transistor Q2 is turned on, the first inductor L1 discharges to the output to provide the output voltage VOUT.

In some embodiments, still referring to FIG. 1, an output capacitor Cout is further disposed at the output terminal of the switched-mode power supply. A first terminal of the output capacitor Cout is electrically connected to the second terminal of the first inductor L1, and a second terminal of the output capacitor Cout is electrically connected to the GND terminal. The output capacitor Cout primarily implements the functions of filtering and voltage regulation.

Furthermore, in a case where the switched-mode power supply operates in the discontinuous conduction mode, two specific control modes may be employed. The first is a constant off-time peak current control mode, and the second is a constant on-time valley current control mode. In a case where the constant off-time peak current control mode is employed, the off-time of the second transistor Q2 is kept constant within each switching cycle. In a case where the inductor current in the branch of the first inductor L1 is detected to have reached a peak value, the first transistor Q1 is turned off to stop the charging process, and simultaneously, the second transistor Q2 is turned on to enable discharging to the output. In a case where the constant on-time valley current control mode is employed, the charging time is constant within each switching cycle. That is, the first transistor Q1 is first turned on, and after a constant charging duration, the first transistor Q1 is turned off to end the charging process. Simultaneously, the second transistor Q2 is turned on to discharge to the output. In a case where the inductor current in the branch of the first inductor L1 is detected to have reached a valley value, the second transistor Q2 is turned off to end the discharging process.

In the present disclosure, both the first transistor Q1 and the second transistor Q2 may be implemented using n-channel metal-oxide-semiconductor field-effect transistors (NMOSFETs). In other embodiments, the first transistor Q1 and the second transistor Q2 may also be implemented using p-channel metal-oxide-semiconductor field-effect transistor (PMOSFET). For example, in a case where the first transistor Q1 and the second transistor Q2 are implemented as NMOSFETs, first terminals of the first transistor Q1 and the second transistor Q2 are drains, second terminals of the first transistor Q1 and the second transistor Q2 are sources, and control electrodes of the first transistor Q1 and the second transistor Q2 are gates.

The control circuit according to the present disclosure is further described hereinafter in conjunction with two specific control modes of the switched-mode power supply circuit 10 in the discontinuous conduction mode.

FIG. 2 is a schematic structural diagram of a control circuit for a switched-mode power supply according to an embodiment of the present disclosure. Referring to FIG. 2, the control circuit includes a current sampling circuit 21, an inductor current ripple sampling circuit 22, a compensation current selection circuit 23, a current compensation circuit 24, a first resistor Ri, a second resistor Rsns, a first comparator COMP1, an inductor current sampling circuit 25, and a logic control circuit 20.

The current sampling circuit 21 is configured to sample a voltage value of the output voltage VOUT at the output terminal of the switched-mode power supply 10 and acquire a current value of a loop compensation current Icmp based on the voltage value of the output voltage VOUT. For example, a voltage-to-current conversion circuit may calculate the corresponding current value of the loop compensation current Icmp based on the voltage value of the sampled output voltage VOUT. The inductor current ripple sampling circuit 22 is configured to sample a voltage value of the input voltage VIN and the voltage value of the output voltage VOUT of the switched-mode power supply 10, calculate an inductor current ripple value Ipp of the switched-mode power supply based on the voltage value of the input voltage VIN and the voltage value of the output voltage VOUT, and generate a current value of a half-ripple control current Ipp1 based on the inductor current ripple value Ipp. The current value of the half-ripple control current Ipp1 is equivalent to half of the inductor current ripple value Ipp, i.e., Ipp1=0.5*Ipp. The compensation current selection circuit 23 is configured to determine a target control current Ipp2 based on the loop compensation current Icmp and the half-ripple control current Ipp1. For example, one with a greater current value between the loop compensation current Icmp and the half-ripple control current Ipp1 is determined as the target control current Ipp2. In other words, the compensation current selection circuit 23 may be understood as a current selection module that compares the current value of the loop compensation current Icmp with the current value of the half-ripple control current Ipp1 and selects one with a greater current value between the loop compensation current Icmp and the half-ripple control current Ipp1 as the target control current Ipp2.

The current compensation circuit 24 is configured to, in a case where the switched-mode power supply 10 operates in a peak current control mode, add the current value of the half-ripple control current Ipp1 to the current value of the target control current Ipp2 to acquire a current value of a loop control current Iloop; or configured to, in a case where the switched-mode power supply 10 operates in a valley current control mode, acquire a current value of a loop control current Iloop based on a current difference value between the current value of the target control current Ipp2 and the current value of the half-ripple control current Ipp1. The peak current control mode specifically refers to the constant off-time peak current control mode, and the valley current control mode specifically refers to the constant on-time valley current control mode. For the specific operating principles of these two modes, reference may be made to the description above, which are not described herein any further.

The inductor current sampling circuit 25 is configured to sample a current value of an inductor current IL in the branch where the first inductor L1 is located and transmit the inductor current IL to a non-inverting input terminal of the first comparator COMP1 via the first resistor Ri. Upon the inductor current IL passes through the first resistor Ri, a first voltage V1 is obtained. The second resistor Rsns is configured to transmit the loop control current Iloop output by the current compensation circuit 24 to an inverting input terminal of the first comparator. Upon the loop control current Iloop passes through the second resistor, a second voltage value V2 is obtained. The first comparator COMP1 is configured to compare the voltage value of the first voltage V1 with the voltage value of the second voltage V2, and output a first control signal Cmpo to the logic control circuit 20 in a case where the voltage value of the first voltage V1 is equal to the voltage value of the second voltage V2. The logic control circuit 20 is configured to output a corresponding drive signal to the first transistor Q1 and the second transistor Q2 based on the first control signal Cmpo. The drive signal is configured to drive the first transistor Q1 and/or the second transistor Q2 to turn on or turn off.

In the control circuit for the switched-mode power supply according to this embodiment, the inductor current ripple sampling circuit 22 may calculate the inductor current ripple value Ipp based on the voltage value of the input voltage VIN and the voltage value of the output voltage VOUT, and generate the current value of the half-ripple control current Ipp1 based on the inductor current ripple value Ipp. The current value of the half-ripple control current Ipp1 is equivalent to a center value of the inductor current ripple IL. In a case where the switched-mode power supply 10 undergoes mode switching and the ripple on the output voltage VOUT is large, the center value of the inductor current ripple IL (i.e., the midpoint value between the maximum current value and the minimum current value) changes very little before and after the mode switching. Then, the compensation current selection circuit 23 determines one with a greater current value between the loop compensation current Icmp and the half-ripple control current Ipp1 as the target control current Ipp2. This means that in a case where the current value of the loop compensation current Icmp is greater than the current value of the half-ripple control current Ipp1, the loop compensation current Icmp is determined as the target control current Ipp2; or in a case where the current value of the loop compensation current Icmp is less than the current value of the half-ripple control current Ipp1, the half-ripple control current Ipp1 is determined as the target control current Ipp2. This ensures that the minimum current value of the determined target control current Ipp2 is not less than the current value of the half-ripple control current Ipp1. Finally, in a case where the switched-mode power supply 10 operates in the peak current control mode, the current compensation circuit 24 adds the current value of the half-ripple control current Ipp1 to the current value of the target control current Ipp2 to acquire the current value of the loop control current Iloop. The resulting loop control current Iloop, which current value is equal to the sum of the current value of the target control current Ipp2 and the current value of the half-ripple control current Ipp1, represents the peak value of the current. In a case where the switched-mode power supply 10 operates in the valley current control mode, the current value of the loop control current Iloop is acquired based on the current difference value between the current value of the target control current Ipp2 and the current value of the half-ripple control current Ipp1. That is, the current difference value acquired by subtracting the current value of the half-ripple control current Ipp1 from the current value of the target control current Ipp2 serves as the current value of the loop control current Iloop, which represents the valley value of the current. Since the minimum current value of the target control current Ipp2 is the current value of the half-ripple control current Ipp1, the minimum valley value of the resulting loop control current Iloop is zero. It is evident that with this method, the maximum difference between the peak and valley values of the loop control current Iloop is small. This effectively maintains the center value of the inductor current IL around the current value of the half-ripple control current Ipp1 before and after mode switching.

Therefore, during control of the switched-mode power supply by the control circuit according to this embodiment based on the loop control current Iloop, the switched-mode power supply may be enabled to adaptively adjust the output loop control current Iloop during mode switching, and further perform loop control on the switched-mode power supply based on the loop control current, such that the central value of the output voltage remains substantially consistent before and after the mode switching. This prevents the generation of large ripples in the output voltage and ensures the operational stability of the switched-mode power supply.

Still referring to FIG. 2, an input terminal of the current sampling circuit 21 is electrically connected the output terminal of the switched-mode power supply 10 to sample a voltage value of the output voltage VOUT. An output terminal of the current sampling circuit 21 is electrically connected a first input terminal of the compensation current selection circuit 23 to output the sampled loop compensation current Icmp to the compensation current selection circuit 23. Two sampling terminals of the inductor current ripple sampling circuit 22 are respectively electrically connected to the input terminal and the output terminal of the switched-mode power supply 10 to sample the voltage value of the input voltage VIN and the output voltage VOUT. An output terminal of the inductor current ripple sampling circuit 22 is electrically connected to a second input terminal of the compensation current selection circuit 23 to output the generated half-ripple control current Ipp1 to the compensation current selection circuit 23.

An output terminal of the compensation current selection circuit 23 is electrically connected to an input terminal of the current compensation circuit 24 to output the selected target control current Ipp2 to the current compensation circuit 24. An output terminal of the current compensation circuit 24 is electrically connected the inverting input terminal of the first comparator COMP1 via the second resistor Rsns. A sampling terminal of the inductor current sampling circuit 25 is electrically connected a connection node where the first terminal of the first inductor L1, the second terminal of the first transistor Q1, and the first terminal of the second transistor Q2 are electrically connected. An output terminal of the inductor current sampling circuit 25 is electrically connected the non-inverting input terminal of the first comparator COMP1 via the first resistor Ri. An output terminal of the first comparator COMP1 is electrically connected a first input terminal of the logic control circuit 20. A first output terminal of the logic control circuit 20 is electrically connected the control electrode of the first transistor Q1, and a second output terminal of the logic control circuit 20 is electrically connected the control electrode of the second transistor Q2.

Still referring to FIG. 2, in some embodiments, the control circuit further includes a first timer circuit 26 and a second timer circuit 27. Two input terminals of the first timer circuit 26 are respectively electrically connected to the input terminal and the output terminal of the switched-mode power supply 10, and an output terminal of the first timer circuit 26 is electrically connected to a second input terminal of the logic control circuit 20. Two input terminals of the second timer circuit 27 are respectively electrically connected to the output terminal of the current sampling circuit 21 and the output terminal of the inductor current ripple sampling circuit 22, and an output terminal of the second timer circuit 27 is electrically connected to a third input terminal of the logic control circuit 20. The first timer circuit 26 and the second timer circuit 27 are configured to generate corresponding clock trigger signals under different control modes, respectively, such that the logic control circuit 20 generates corresponding drive signals based on these clock trigger signals to drive the corresponding transistors to turn on or turn off.

FIG. 3 is a first schematic structural diagram of a first timer circuit 26 according to an embodiment of the present disclosure. Referring to FIG. 3, the first timer circuit 26 includes a second comparator COMP2, a third resistor Rcot, and a first capacitor Ccot.

A first terminal of the third resistor Rcot is electrically connected the input terminal of the switched-mode power supply 10 to receive the input voltage VIN of the switched-mode power supply 10. A second terminal of the third resistor Rcot is electrically connected a first terminal of the first capacitor Ccot. A second terminal of the first capacitor Ccot is grounded. The first terminal of the first capacitor Ccot is further electrically connected to a non-inverting input terminal of the second comparator COMP2, which is configured to receive a voltage value of a third voltage at the first terminal of the first capacitor Ccot. An inverting input terminal of the second comparator COMP2 is configured to receive a reference voltage value.

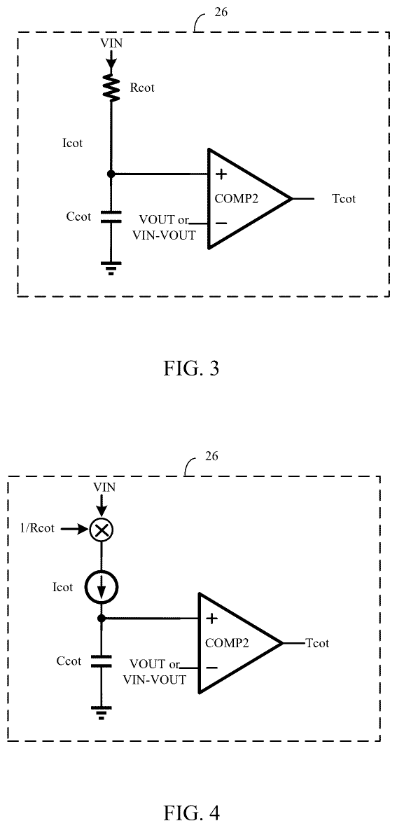

FIG. 4 is a second schematic structural diagram of another first timer circuit according to an embodiment of the present disclosure. The structure of the first timer circuit in FIG. 4 differs from that in FIG. 3 in that a multiplier is used to replace the third resistor Rcot. Referring to FIG. 4, an input terminal of the multiplier serves as an input terminal of the first timer circuit 26 and is configured to receive the input voltage of the switched-mode power supply 10. An output terminal of the multiplier is electrically connected to the first terminal of the first capacitor Ccot. The second terminal of the first capacitor Ccot is grounded. The first terminal of the first capacitor Ccot is further electrically connected to the non-inverting input terminal of the second comparator COMP2, and an output terminal of the second comparator COMP2 is electrically connected the second input terminal of the logic control circuit 20. The input terminal of the first timer circuit 26 receives the input voltage VIN from the switched-mode power supply 10. The multiplier then multiplies the voltage value of the input voltage by 1/R_{Rcot}, wherein R_{Rcot} represents a resistance value of the third resistor Rcot. This is equivalent to forming a current source Icot. The current source Icot charges the first capacitor Ccot, and then the non-inverting input terminal of the second comparator COMP2 samples the voltage value of the third voltage at the first terminal of the first capacitor Ccot.

It may be understood that the corresponding reference voltage value varies as the switched-mode power supply 10 operates in different modes. That is, the reference voltage values received by the inverting input terminal of the second comparator COMP2 are different in a case where the switched-mode power supply 10 operates in the peak current control mode and the valley current control mode respectively.

Specifically, in one application scenario, the inverting input terminal of the second comparator COMP2 is configured to receive the output voltage VOUT of the switched-mode power supply 10 in the peak current control mode. That is, the output voltage VOUT serves as the reference voltage value in the peak current control mode. In another application scenario, the inverting input terminal of the second comparator COMP2 is configured to receive a first difference value in the valley current control mode, wherein the first difference value is a voltage difference value between the voltage value of the input voltage VIN and the voltage value of the output voltage VOUT of the switched-mode power supply 10. That is, the first difference value may be expressed as VIN-VOUT. The second comparator COMP2 is configured to, in the peak current control mode, compare the voltage value of the third voltage on the first capacitor Ccot with the voltage value of the output voltage VOUT, and output a first clock signal Tcot in a case where the voltage value of the third voltage is equal to the voltage value of the output voltage VOUT. Alternatively, the second comparator COMP2 is configured to, in the valley current control mode, compare the voltage value of the third voltage with the first difference value, and output the first clock signal Tcot in a case where the voltage value of the third voltage is equal to the first difference value.

The logic control circuit 20 is configured to, in the peak current control mode, generate a first drive signal based on the first clock signal Tcot, wherein the first drive signal is configured to drive the second transistor Q2 to turn off. Alternatively, the logic control circuit 20 is configured to, in the valley current control mode, generate a second drive signal and a third drive signal based on the first clock signal Tcot, wherein the second drive signal is configured to drive the first transistor Q1 to turn off, and the third drive signal is configured to drive the second transistor Q2 to turn on.

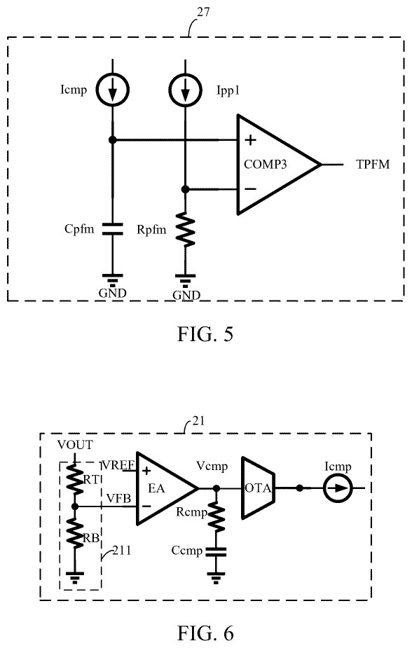

FIG. 5 is a schematic structural diagram of a second timer circuit 27 according to an embodiment of the present disclosure. Referring to FIG. 5, the second timer circuit 27 according to this embodiment includes a second capacitor Cpfm, a fourth resistor Rpfm, and a third comparator COMP3.

A first terminal of the second capacitor Cpfm is electrically connected the output terminal of the current sampling circuit 21, and a second terminal of the second capacitor Cpfm is electrically connected GND. The first terminal of the second capacitor Cpfm is further electrically connected to a non-inverting input terminal of the third comparator COMP3. A first terminal of the fourth resistor Rpfm is electrically connected the output terminal of the inductor current ripple sampling circuit 22, and a second terminal of the fourth resistor Rpfm is electrically connected GND. The first terminal of the fourth resistor Rpfm is further electrically connected to an inverting input terminal of the third comparator COMP3. An output terminal of the third comparator COMP3 is electrically connected the logic control circuit 20.

The non-inverting input terminal of the third comparator COMP3 is configured to sample a voltage value of a fourth voltage at the first terminal of the second capacitor Cpfm. The inverting input terminal of the third comparator COMP3 is configured to sample a voltage value of a fifth voltage at the first terminal of the fourth resistor Rpfm. The third comparator COMP3 is configured to compare the voltage value of the fourth voltage with the voltage value of the fifth voltage, and output a second clock signal Tpfm in a case where the voltage value of the fourth voltage is equal to the voltage value of the fifth voltage. The logic control circuit 20 is configured to, in the peak current control mode or the valley current control mode, generate a fourth drive signal based on the second clock signal Tpfm. The fourth drive signal is configured to drive the first transistor Q1 to turn on.

In this embodiment, the second timer circuit 27 is mainly configured to measure a discharging duration. In a case where the discharging duration of the switched-mode power supply 10 reaches a predetermined value, the first transistor Q1 needs to be turned on to initiate charging.

Specifically, the loop compensation current Icmp output by the current sampling circuit 21 may charge the second capacitor Cpfm to acquire the fourth voltage of the second capacitor Cpfm. Concurrently, the half-ripple control current Ipp1 output by the inductor current ripple sampling circuit 22 generates a voltage drop across the fourth resistor Rpfm, resulting in the fifth voltage of the fourth resistor Rpfm. The magnitude of the current value of the loop compensation current Icmp determines the charging speed of the second capacitor Cpfm; and a larger of the current value of the loop compensation current Icmp results in a faster charging speed. In a case where the voltage value of the fourth voltage becomes equal to the voltage value of the fifth voltage, the discharging is complete, which may then trigger the first transistor Q1 to turn on for charging.

In this embodiment, resistance values of the third resistor Rcot and the fourth resistor Rpfm are the same, and capacitance values of the first capacitor Ccot and the second capacitor Cpfm are the same. This ensures consistency in device parameters, which in turn helps to keep a central value of the output voltage substantially consistent before and after mode switching.

FIG. 6 is a schematic structural diagram of a current sampling circuit 21 according to an embodiment of the present disclosure. Referring to FIG. 6, the current sampling circuit 21 includes a voltage divider circuit 211, an error amplifier EA, and a transconductance amplifier OTA.

A sampling terminal of the voltage divider circuit 211 is electrically connected the output terminal of the switched-mode power supply 10 to sample the voltage value of the output voltage VOUT. An output terminal of the voltage divider circuit 211 is electrically connected an inverting input terminal of the error amplifier EA. The inverting input terminal of the error amplifier EA is configured to receive a first divided voltage VFB from the voltage divider circuit, and a non-inverting input terminal of the error amplifier EA is configured to receive a reference voltage value VREF. The error amplifier EA is configured to calculate an error voltage value between a voltage value of the first divided voltage VFB and the reference voltage value VREF, and amplify the error voltage value to acquire a voltage value of a loop compensation voltage Vcmp. An output terminal of the error amplifier EA is electrically connected an input terminal of the transconductance amplifier OTA. The transconductance amplifier OTA is configured to generate the loop compensation current Icmp based on the loop compensation voltage Vcmp.

Still referring to FIG. 6, the voltage divider circuit 211 according to this embodiment includes a fifth resistor RT and a sixth resistor RB. A first terminal of the fifth resistor RT serves as the sampling terminal of the voltage divider circuit 211 for sampling the output voltage VOUT of the switched-mode power supply 10. A second terminal of the fifth resistor RT is electrically connected a first terminal of the sixth resistor RB, and a second terminal of the sixth resistor RB is electrically connected to the GND terminal. The connection node between the second terminal of the fifth resistor RT and the first terminal of the sixth resistor RB serves as the output terminal of the voltage divider circuit 211, to output the sampled first divided voltage VFB.

Still referring to FIG. 6, in some embodiments, the current sampling circuit 21 further includes a seventh resistor Rcmp and a third capacitor Comp. The output terminal of the error amplifier EA is electrically connected a first terminal of the seventh resistor Rcmp. A second terminal of the seventh resistor Rcmp is electrically connected a first terminal of the third capacitor Comp, and a second terminal of the third capacitor Comp is electrically connected to the GND terminal. The seventh resistor Rcmp and the third capacitor Comp in this embodiment form an RC filter circuit to filter out interference signals, such that the sampled loop compensation voltage Vcmp is more accurate.

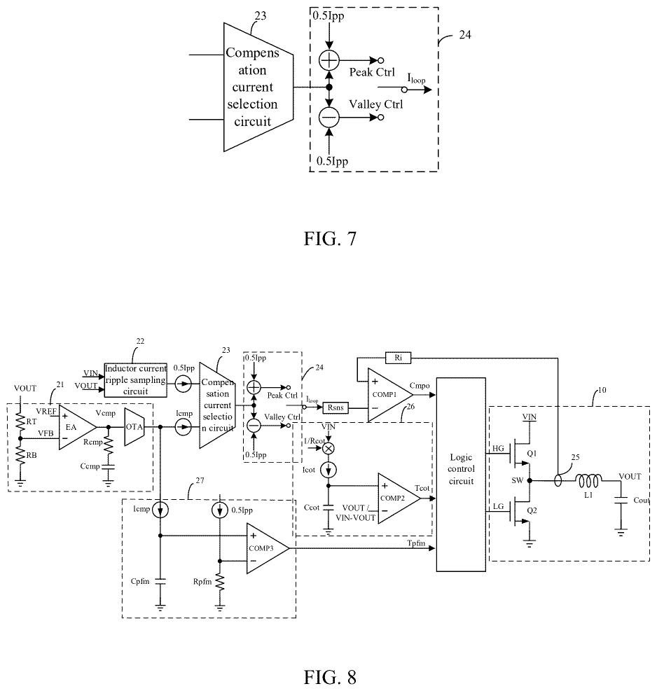

FIG. 7 is a schematic structural diagram of a current compensation circuit according to an embodiment of the present disclosure. Referring to FIG. 7, the current compensation circuit 24 of this embodiment may specifically include an adder, a subtractor, and a selection switch. Two input terminals of the adder are respectively electrically connected to the output terminal of the inductor current ripple sampling circuit 22 and the output terminal of the compensation current selection circuit 23. An output terminal of the adder is electrically connected to the selection switch. Two input terminals of the subtractor are respectively electrically connected to the output terminal of the inductor current ripple sampling circuit 22 and the output terminal of the compensation current selection circuit 23. An output terminal of the subtractor is electrically connected to the selection switch.

The compensation current selection circuit 23 outputs the target control current Ipp2 to the current compensation circuit 24. The current compensation circuit 24 then processes the target control current Ipp2 in two separate paths. A first path is for the peak current control mode (Peak Ctrl), wherein the adder adds the current value (i.e., 0.5*Ipp) of the half-ripple control current Ipp1 to the current value of the target control current Ipp2 to acquire the current value of the loop control current Iloop. A second path is for the valley current control mode (Valley Ctrl), wherein the subtractor subtracts the current value of the half-ripple control current Ipp1 from the current value of the target control current Ipp2 to acquire the current value of the loop control current Iloop. Finally, the selection switch selects to be electrically connected to the output terminal of the corresponding adder or subtractor based on the current operating mode of the switched-mode power supply 10. For example, in the peak current control mode (Peak Ctrl), the selection switch is electrically connected to the output terminal of the adder to output the loop control current Iloop generated from the adder to the second resistor Rsns. In the valley current control mode (Valley Ctrl), the selection switch is electrically connected to the output terminal of the subtractor to output the loop control current Iloop generated from the subtractor to the second resistor Rsns. This process achieves the compensation of the target control current Ipp2 to generate the final loop control current Iloop.

In this embodiment, the calculation of the inductor current ripple value of the switched-mode power supply based on the input and output voltages specifically includes: by the inductor current ripple sampling circuit 22, acquiring the inductance value of the first inductor and the switching frequency of the switched-mode power supply, and calculating the inductor current ripple value according to Formula (1):

$$I P P = \frac{( Vin - Vout ) \times Vout}{Vin} \times \frac{1}{{L}_{L} \times Fsw} \times \frac{{R}_{Ri}}{{R}_{Rsns}} \qquad ( 1 )$$

In Formula (1), Ipp represents the inductor current ripple value, Vin represents the voltage value of the input voltage of the switched-mode power supply, Vout represents the voltage value of the output voltage of the switched-mode power supply, L_{L} represents the inductance value of the first inductor, Fsw represents the switching frequency of the switched-mode power supply, R_{Ri} represents the resistance value of the first resistor, and R_{Rsns} represents the resistance value of the second resistor.

It may be understood that the inductor current ripple sampling circuit 22 may be designed with a specific logic calculation circuit according to Formula (1) to implement the calculation process, thereby outputting the inductor current ripple value Ipp and further outputting the half-ripple control current Ipp1 such that Ipp1=0.5*Ipp. Thus, Ipp1 may represent half of the inductor current ripple value.

FIG. 8 is a schematic diagram of the overall structure of the control circuit for the switched-mode power supply according to an embodiment of the present disclosure. Referring to FIG. 8, in a specific embodiment, the control circuit includes a current sampling circuit 21, an inductor current ripple sampling circuit 22, a compensation current selection circuit 23, a current compensation circuit 24, a first resistor Ri, a second resistor Rsns, a first comparator COMP1, an inductor current sampling circuit 25, a first timer circuit 26, a second timer circuit 27, and a logic control circuit 20.

The logic control circuit 20 is specifically configured to, in the peak current control mode, output a fifth drive signal and a sixth drive signal based on the first control signal, wherein the fifth drive signal is configured to drive the first transistor Q1 to turn off, and the sixth drive signal is configured to drive the second transistor Q2 to turn on. Alternatively, the logic control circuit 20 is configured to, in the valley current control mode, output a seventh drive signal based on the first control signal, wherein the seventh drive signal is configured to drive the second transistor Q2 to turn off.

In some embodiments, the logic control circuit 20 is further configured to receive a mode switching signal. The mode switching signal is configured to control the switched-mode power supply to switch between the continuous conduction mode and the discontinuous conduction mode.

Specifically, in a case where the logic control circuit 20 determines that the switched-mode power supply is currently operating in the continuous conduction mode based on the received mode switching signal, the logic control circuit 20 may immediately control the first transistor Q1 to turn on after the second transistor Q2 is turned off, in order to initiate charging and energy storage.

In some embodiments, in a case where the switched-mode power supply is currently operating in the discontinuous conduction mode, the logic control circuit 20 is further configured to, after the second transistor Q2 is turned off, determine whether the switched-mode power supply 10 operates in the discontinuous conduction mode. In a case where it is determined that the switched-mode power supply 10 operates in the discontinuous conduction mode, the logic control circuit 20 then detects whether the second clock signal Tpfm has been received. In a case where the second clock signal Tpfm has not been received, the logic control circuit 20 outputs an eighth drive signal, wherein the eighth drive signal is configured to drive the first transistor Q1 to turn on, thereby causing the circuit to start charging and storing energy.

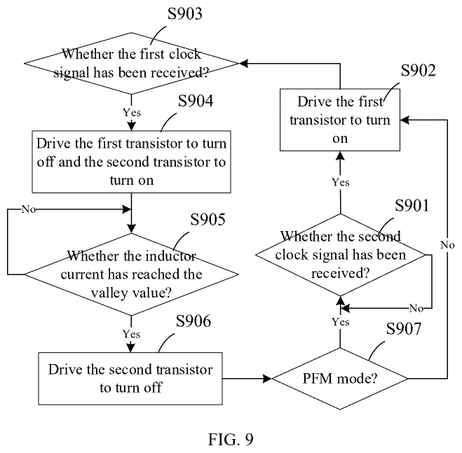

FIG. 9 is a flowchart of the operations of the logic control circuit in the constant on-time valley current control mode according to an embodiment of the present disclosure. The operating process is as follows:

In S901, in the constant on-time valley current control mode, within a switching cycle, the logic control circuit first detects whether the second clock signal Tpfm has been received.

In a case where the second clock signal Tpfm has been received, the process proceeds to S902. In a case where the second clock signal Tpfm has not been received, S901 is repeated.

In S902, the logic control circuit outputs the fourth drive signal to the first transistor Q1 to drive the first transistor Q1 to turn on. The process then proceeds to S903.

In S903, the logic control circuit detects whether the first clock signal Tcot has been received. In a case where the first clock signal Tcot has been received, the process proceeds to S904.

In S904, the logic control circuit outputs the second drive signal to the first transistor Q1 to drive the first transistor Q1 to turn off, and outputs the third drive signal to the second transistor Q2 to drive the second transistor Q2 to turn on. The process then proceeds to S905.

In S905, the logic control circuit detects whether the inductor current has reached the valley value. In a case where the inductor current has reached the valley value, the process proceeds to S906. In a case where the inductor current has not reached the valley value, S905 is repeated.

For example, in a case where the first control signal has been received, it is determined that the inductor current has reached the valley value.

In S906, the logic control circuit outputs the seventh drive signal to the second transistor Q2 to drive the second transistor Q2 to turn off. The process then proceeds to S907.

In S907, whether the switched-mode power supply 10 operates in the PFM mode is determined.

In a case where the switched-mode power supply 10 operates in the PFM mode, the process returns to S901 to determine whether the second clock signal Tpfm has been received. In a case where the second clock signal Tpfm has not been received, the process proceeds to S902 to control the first transistor Q1 to turn on.

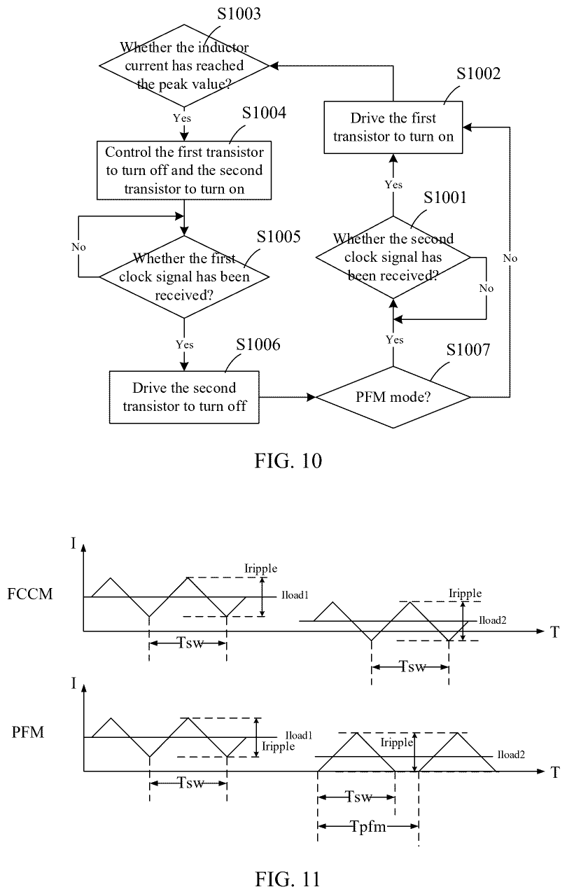

FIG. 10 is a flowchart of the operations of the logic control circuit in the constant off-time peak current control mode according to an embodiment of the present disclosure. The operating process is as follows:

In S1001, in a case where the switched-mode power supply operates in the constant off-time peak current control mode, within a switching cycle, the logic control circuit first detects whether the second clock signal Tpfm has been received.

In a case where the second clock signal Tpfm has been received, the process proceeds to S1002. In a case where the second clock signal Tpfm has not been received, S1001 is repeated.

In S1002, the logic control circuit outputs the fourth drive signal to the first transistor Q1 to drive the first transistor Q1 to turn on. The process then proceeds to S1003.

In S1003, the logic control circuit detects whether the inductor current has reached the peak value. In a case where the inductor current has reached the peak value, the process proceeds to S1004.

For example, in a case where the first control signal has been received, it is determined that the inductor current has reached the peak value.

In S1004, the logic control circuit controls the first transistor Q1 to turn off and controls the second transistor Q2 to turn on. The process then proceeds to S1005.

In S1005, the logic control circuit detects whether the first clock signal Tcot has been received. In a case where the first clock signal Tcot has been received, the process proceeds to S1006. In a case where the first clock signal Tcot has not been received, S1005 is repeated.

In S1006, the logic control circuit outputs the first drive signal to the second transistor Q2 to drive the second transistor Q2 to turn off. The process then proceeds to S1007.

In S1007, after the second transistor Q2 is turned off, the logic control circuit determines whether the switched-mode power supply 10 operates in the PFM mode.

In a case where the switched-mode power supply 10 operates in the PFM mode, the process returns to S1001 to determine whether the second clock signal Tpfm has been received. In a case where the switched-mode power supply 10 is not operating in the PFM mode, the process proceeds to S1002 to control the first transistor Q1 to turn on.

From the above description, it is evident that in this embodiment, based on the first timer circuit 26 and the second timer circuit 27, the on-time and off-time may be adaptively generated. Specifically, the on-time and off-time are adjusted in response to changes in the input voltage VIN and the output voltage VOUT, such that the switching frequency FSW of the switched-mode power supply 10 is adjusted.

During generation of an adaptive on-time, the switched-mode power supply operates in the peak current control mode, and an input voltage value of the inverting input terminal of the second comparator COMP2 is the output voltage value V_{OUT}. During generation of an adaptive off-time, the switched-mode power supply operates in the valley current control mode, and the input voltage value of the inverting input terminal of the second comparator COMP2 is V_{IN}−V_{OUT}. By calculation, a stable switching period is acquired, which may be calculated according to Formula (2):

$$Tsw = {R}_{Rcot} \times {C}_{{c}_{Cot}} \qquad ( 2 )$$

In Formula (2), Tsw represents the switching period, R_{Rcot} represents the resistance value of the third resistor, and C_{c}_{_{Cot}} represents the capacitance value of the first capacitor.

As described above, the inductor current ripple sampling circuit 22 outputs the half-ripple control current Ipp1. In the peak current or valley current control modes, the final loop control current Iloop is acquired based on the half-ripple control current Ipp1 and the current compensation circuit 24. The loop control current Iloop, which is input to the first comparator COMP1, determines the peak or valley of the inductor current. The peak or valley value of the inductor current ripple IL may be calculated according to Formula (3):

$${I}_{IL} = {I}_{Iloop} \frac{{R}_{Rsns}}{{R}_{Ri}} \qquad ( 3 )$$

In Formula (3), I_{IL} represents the peak or valley value of the inductor current ripple IL, I_{Iloop} represents the current value of the loop control current, R_{Ri} represents the resistance value of the first resistor, and R_{Rsns} represents the resistance value of the second resistor.

Therefore, the half-ripple control current Ipp1 represents half of the inductor current ripple, and the current value of the loop compensation current Icmp represents the center value of the inductor current. For a buck converter, the center value of the inductor current is equal to a current value of the load current. Thus, in the switched-mode power supply, the loop compensation current Icmp represents the load current. In a case where the switched-mode power supply operates in the forced continuous conduction mode, the compensation current selection circuit 23 is inactive, and the loop compensation current Icmp continuously regulates the inductor current. In this case, the relationship between the loop compensation current Icmp and the load current Iload satisfies Formula (4):

$${I}_{Iload} = \frac{{R}_{Rsns}}{{R}_{Ri}} \times {I}_{Icmp} \qquad ( 4 )$$

In Formula (4), I_{Iload} represents the current value of the load current, R_{Ri} represents the resistance value of the first resistor, R_{Rsns} represents the resistance value of the second resistor, and I_{Icmp} represents the current value of the loop compensation current.

In a case where the switched-mode power supply switches to the PFM mode, the compensation current selection circuit 23 becomes active. Under heavy load conditions, the operating state is the same as that in the forced continuous conduction mode. As the load gradually decreases, the valley of the inductor current ripple reaches zero. In this case, the current value of the loop compensation current Icmp becomes exactly equal to the current value of the half-ripple control current Ipp1, i.e., 0.5*Ipp. In a case where the load continues to decrease, the loop control current Iloop may not decrease further. This ensures that the valley value of the inductor current does not drop any lower in response to reaching zero. Furthermore, the inductor current ripple in response to the switched-mode power supply entering the discontinuous conduction mode is equal to the inductor current ripple in the forced continuous conduction mode. In this case, the control of the loop is regulated by the second timer circuit 27.

FIG. 11 is a schematic diagram of operating waveforms of the inductor current in a case where the switched-mode power supply operates in the forced continuous conduction mode and the PFM mode according to an embodiment of the present disclosure. Referring to FIG. 11, Iload1 represents operation in a light-load mode, and Iload2 represents operation in a heavy-load mode. It is apparent that with the control circuit according to this embodiment, the magnitude of the inductor current ripple Iripple remains constant regardless of whether the switched-mode power supply operates in the forced continuous conduction mode or the PFM mode, and under both light-load and heavy-load conditions. Meanwhile, it is apparent that in the forced continuous conduction mode, the switching period Tsw also remains constant under both heavy-load and light-load conditions. In the PFM mode, the switching period Tpfm under the light-load condition is longer than the switching period Tsw under the heavy-load condition.

With the control circuit according to this embodiment, after the switched-mode power supply switches to the discontinuous conduction mode, the relationship between the loop compensation current Icmp and the load current Iload remains unchanged, still satisfying Formula (4).

In this embodiment, the capacitance value of the second capacitor Cpfm is equal to the capacitance value of the first capacitor Ccot, i.e., C_{Cpfm}=C_{Ccot}, wherein C_{Ccot} represents the capacitance value of the first capacitor Ccot, and C_{Cpfm} represents the capacitance value of the second capacitor Cpfm; and the resistance value of the fourth resistor Rpfm is equal to the resistance value of the third resistor Rcot, i.e., R_{Rpfm}=R_{Rcot}, wherein R_{Rcot} represents the resistance value of the third resistor Rcot, and R_{Rpfm} represents the resistance value of the fourth resistor Rpfm.

In a case where I_{Icmp}=0.5 lpp, the timing of the second timer circuit 27 is exactly equal to one switching period Tsw. That is, in response to the inductor current valley reaching zero, the second timer circuit 27 has just completed the timing, and the next switching cycle may begin. In a case where the load continues to decrease, the loop compensation current Icmp may also continue to decrease. In this case, the timing of the second timer circuit 27 may be extended, thereby extending the switching period. This ensures that the loop continues to provide a stable output without the inductor current peak decreasing further. Furthermore, with the present control circuit, the relationship between the load current Iload and the loop compensation current Icmp remains the same in both the forced continuous conduction mode and the discontinuous conduction mode. In the PFM mode, the relationship between the loop compensation current Icmp and the load current Iload satisfies Formulas (5-1) and (5-2):

$$0.5 \times Tsw \times I p p \times \frac{{R}_{Rsns}}{{R}_{Ri}} = {I}_{Iload} \times Tpfm \qquad ( 5 - 1 )$$

$$Tpfm = \frac{{C}_{Cpfm} \times {R}_{Rpfm} \times 0.5 I p p}{{I}_{Icmp}} \qquad ( 5 - 2 )$$

In Formulas (5-1) and (5-2), Tsw represents the switching period, Tpfm represents the duration of the second clock signal, Ipp represents the inductor current ripple value, R_{Ri} represents the resistance value of the first resistor, R_{Rsns} represents the resistance value of the second resistor, C_{Cpfm} represents the capacitance value of the second capacitor, R_{Rpfm} represents the resistance value of the fourth resistor, I_{Iload} represents the current value of the load current, and I_{Icmp} represents the current value of the loop compensation current.

Upon simplification of Formulas (5-1) and (5-2), the relationship between the loop compensation current Icmp and the load current Iload is found to be the same as their relationship in the forced continuous conduction mode.

Therefore, in this embodiment, in a case where the switched-mode power supply operates in the forced continuous conduction mode and the PFM mode under the same light-load condition, the current values of the loop compensation currents Icmp are equal, which means the current values of the loop compensation voltages Vcmp are also the same. Consequently, in a case where forced mode switching occurs or the input voltage experiences a transient, the loop compensation current Icmp ideally does not need to be adjusted, which ensures that no fluctuations occur in the output voltage.

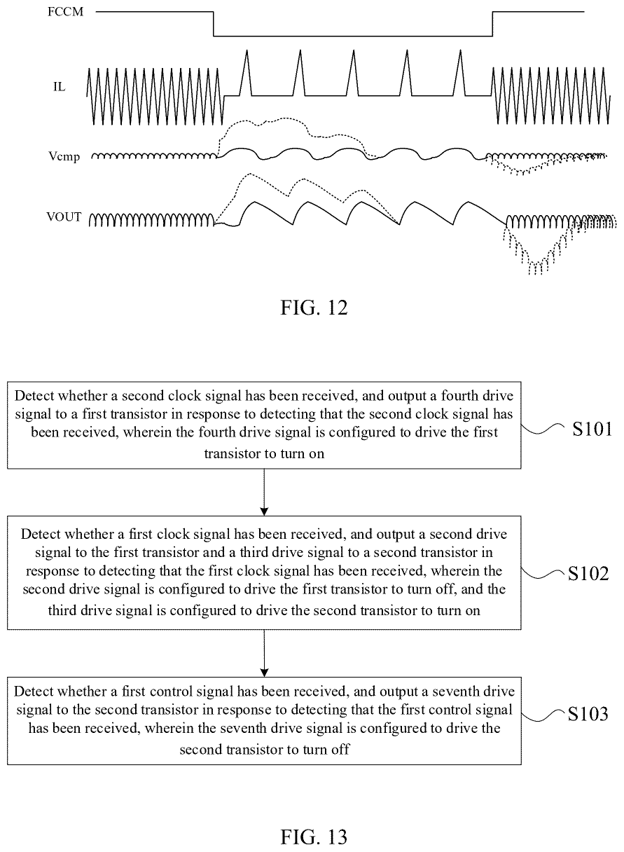

FIG. 12 is a schematic diagram of operating waveforms of the control circuit according to an embodiment of the present disclosure. Referring to FIG. 12, in a case where an FCCM signal is at a high level, the switched-mode power supply operates in the forced continuous conduction mode; or in a case where the FCCM signal transitions to a low level, the switched-mode power supply operates in the discontinuous conduction mode. In FIG. 12, IL represents the waveform of the inductor current, Vcmp represents the waveform of the loop compensation voltage, and VOUT represents the waveform of the output voltage of the switched-mode power supply. The dashed lines represent the waveforms of a control scheme in the related art, while the solid lines represent the waveforms in a case where the control circuit according to the present embodiment is used.

By comparing the waveforms of the loop compensation voltage Vcmp in FIG. 12, it is apparent that with the control circuit according to the present embodiment, the fluctuation in Vcmp is smaller than that in the related art in a case where the switched-mode power supply switches from the forced continuous conduction mode to the discontinuous conduction mode. Furthermore, by comparing the waveforms of the output voltage VOUT, it is evident that with the control circuit according to the present embodiment, the fluctuation in VOUT is also smaller than that in the related art during the mode switching, and the central value of the output voltage VOUT remains almost unchanged compared to the related art.

Thus, the waveforms in FIG. 12 visually demonstrate that the control circuit according to the present embodiment ensures that the central value of the output voltage remains substantially consistent before and after mode switching. This prevents the generation of large ripples in the output voltage and ensures the operational stability of the switched-mode power supply.

An embodiment further provides a control method for a switched-mode power supply, which is applied in the control circuit according to the embodiments above. The control method according to this embodiment may be understood in conjunction with the control circuit according to the above embodiments.

FIG. 13 is a first flowchart of a control method according to an embodiment of the present disclosure. Referring to FIG. 13, in one embodiment, in a case where the switched-mode power supply operates in the constant on-time valley current control mode, the method includes the following steps:

In S101, whether a second clock signal has been received is detected, and a fourth drive signal is output to a first transistor in response to detecting that the second clock signal has been received, wherein the fourth drive signal is configured to drive the first transistor to turn on.

Specifically, in this embodiment, at the beginning of a switching cycle, in a case where the switched-mode power supply 10 operates in the constant on-time valley current control mode, in response to receiving the second clock signal Tpfm from the second timer circuit 27, the logic control circuit 20 determines that the discharging process is complete, and then outputs the fourth drive signal to the first transistor Q1, wherein the fourth drive signal is configured to drive the first transistor Q1 to turn on, such that the switched-mode power supply starts the charging process. Specifically, the input charging voltage VIN charges the first inductor L1 for energy storage, such that the inductor current in L1 gradually increases.

In S102, whether a first clock signal has been received is detected, and a second drive signal is output to the first transistor and a third drive signal is output to a second transistor in response to detecting that the first clock signal has been received, wherein the second drive signal is configured to drive the first transistor to turn off, and the third drive signal is configured to drive the second transistor to turn on.

Specifically, in this embodiment, in response to receiving the first clock signal Tcot from the first timer circuit 26, the logic control circuit 20 determines that the charging is complete. The logic control circuit 20 then outputs the second drive signal to the first transistor Q1 and the third drive signal to the second transistor Q2. The second drive signal is configured drive the first transistor Q1 to turn off, and the third drive signal is configured to drive the second transistor Q2 to turn on. In this way, the switched-mode power supply 10 ends the charging process and begins the discharging process, such that the inductor current in the first inductor L1 gradually decreases.

In S103, whether a first control signal has been received is detected, and a seventh drive signal is output to the second transistor in response to detecting that the first control signal has been received, wherein the seventh drive signal is configured to drive the second transistor to turn off.

Specifically, in this embodiment, during the process where the second transistor Q2 is on and the first inductor L1 is discharging, the logic control circuit 20 detects in real time whether the first control signal Cmpo has been received from the first comparator COMP1. In a case where the first control signal Cmpo has been received, the logic control circuit 20 outputs the seventh drive signal to the second transistor Q2, wherein the seventh drive signal is configured to drive the second transistor Q2 to turn off.

In some embodiments, in response to driving the second transistor Q2 to turn off, the logic control circuit 20 further determines the current operating mode of the switched-mode power supply 10 based on a received mode switching signal. For example, in a case where the logic control circuit 20 determines, based on the received mode switching signal, that the current operating mode of the switched-mode power supply 10 is the forced continuous conduction mode, in response to driving the second transistor Q2 to turn off, the logic control circuit 20 immediately drives the first transistor Q1 to turn on.

In some embodiments, in response to driving the second transistor Q2 to turn off, the logic control circuit 20 further determines, based on the received mode switching signal, whether the switched-mode power supply 10 operates in the discontinuous conduction mode. In a case where the switched-mode power supply 10 operates in the discontinuous conduction mode, the logic control circuit 20 further detects whether the second clock signal Tpfm has been received from the second timer circuit 27. In a case where the second clock signal Tpfm has been received, the logic control circuit 20 outputs the fourth drive signal to the first transistor Q1, wherein the fourth drive signal is configured to drive the first transistor Q1 to turn on, such that the switched-mode power supply 10 starts the charging process and start a next switching cycle. In a case where the switched-mode power supply 10 is not operating in the discontinuous conduction mode, the logic control circuit 20 determines that the current operating mode is the forced continuous conduction mode, and then outputs an eighth drive signal to the first transistor Q1, wherein the eighth drive signal is configured to drive the first transistor Q1 to turn on.

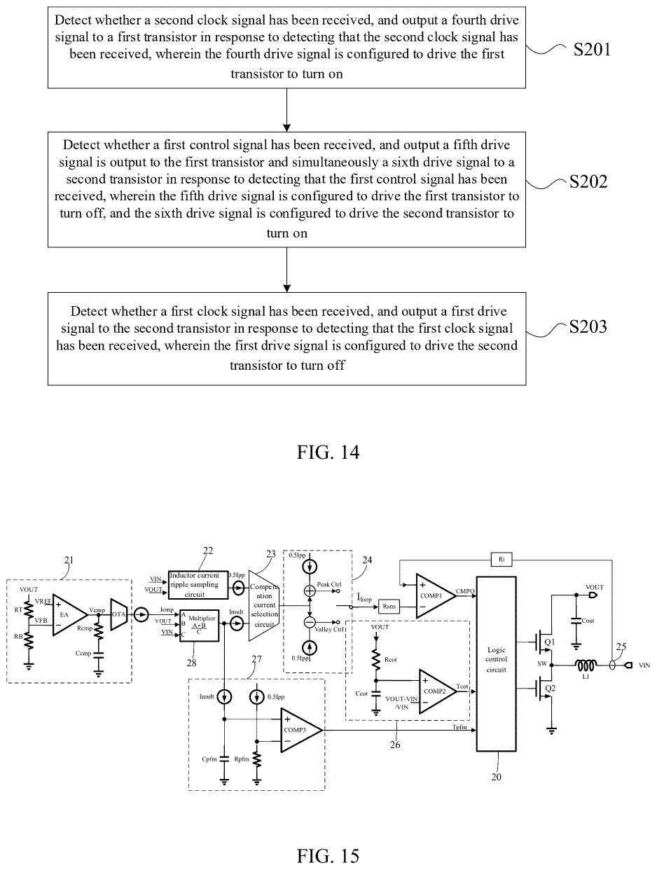

FIG. 14 is a second flowchart of a control method according to an embodiment of the present disclosure. Referring to FIG. 14, in one embodiment, in a case where the switched-mode power supply operates in the constant off-time peak current control mode, the method includes the following steps.

In S201, whether a second clock signal has been received is detected, and a fourth drive signal is output to a first transistor in response to detecting that the second clock signal has been received, wherein the fourth drive signal is configured to drive the first transistor to turn on.

Specifically, in this embodiment, at the beginning of a switching cycle, in a case where the switched-mode power supply 10 operates in the constant off-time peak current control mode, in response to receiving the second clock signal Tpfm from the second timer circuit 27, the logic control circuit 20 determines that the discharging process is complete, and then outputs the fourth drive signal to the first transistor Q1, wherein the fourth drive signal is configured to drive the first transistor Q1 to turn on, such that the switched-mode power supply starts the charging process. Specifically, the input charging voltage VIN charges the first inductor L1 for energy storage, such that the inductor current in the first inductor L1 gradually increases.

In S202, whether a first control signal has been received is detected, and a fifth drive signal is output to the first transistor and simultaneously a sixth drive signal is output to a second transistor in response to detecting that the first control signal has been received, wherein the fifth drive signal is configured to drive the first transistor to turn off, and the sixth drive signal is configured to drive the second transistor to turn on.

Specifically, in this embodiment, while the first inductor L1 is charging and the current therein is increasing, the logic control circuit 20 further detects in real time whether the first control signal Cmpo has been received from the first comparator COMP1. In a case where the first control signal Cmpo has been received, the logic control circuit 20 outputs the fifth drive signal to the first transistor Q1 and the sixth drive signal to the second transistor Q2. The fifth drive signal is configured to drive the first transistor Q1 to turn off, such that the charging process is ended. The sixth drive signal is configured to drive the second transistor Q2 to turn on, such that the switched-mode power supply starts the charging process.

In S203, whether a first clock signal has been received is detected, and a first drive signal is output to the second transistor in response to detecting that the first clock signal has been received, wherein the first drive signal is configured to drive the second transistor to turn off.

Specifically, in this embodiment, while the second transistor Q2 is on and the first inductor L1 is discharging, the logic control circuit 20 further detects in real time whether the first clock signal Tcot has been received from the first timer circuit 26. In a case where the first clock signal Tcot has been received, the logic control circuit 20 outputs the first drive signal to the second transistor Q2, wherein the first drive signal is configured to drive the second transistor Q2 to turn off.

In some embodiments, in response to driving the second transistor Q2 to turn off, the logic control circuit 20 further determines the current operating mode of the switched-mode power supply 10 based on a received mode switching signal. For example, in a case where the logic control circuit 20 determines, based on the received mode switching signal, that the current operating mode of the switched-mode power supply 10 is the forced continuous conduction mode, in response to driving the second transistor Q2 to turn off, the logic control circuit 20 immediately drives the first transistor Q1 to turn on.

In some embodiments, in response to turning the second transistor Q2 off, the logic control circuit 20 further determines, based on the received mode switching signal, whether the switched-mode power supply 10 operates in the discontinuous conduction mode. In a case where the switched-mode power supply 10 operates in the discontinuous conduction mode, the logic control circuit 20 further detects whether the second clock signal Tpfm has been received from the second timer circuit 27. In a case where the second clock signal Tpfm has been received, the logic control circuit 20 outputs a drive signal to the first transistor Q1, wherein the drive signal is configured to drive the first transistor Q1 to turn on, such that the switched-mode power supply 10 starts the charging process and start a next switching cycle. In a case where the switched-mode power supply 10 is not operating in the discontinuous conduction mode, the logic control circuit 20 determines that the current operating mode is the forced continuous conduction mode, and then outputs an eighth drive signal to the first transistor Q1, wherein the eighth drive signal is configured to drive the first transistor Q1 to turn on.

It may be understood that the control methods according to the embodiments above may be implemented in the logic control circuit 20. The logic control circuit 20 may be a logic control chip integrated with various drive circuits to control the switched-mode power supply according to the methods according to the above embodiments.

With the control method for the switched-mode power supply according to this embodiment, and based on the first timer circuit 26 and the second timer circuit 27, the on-time and off-time may be adaptively generated. Specifically, the on-time and off-time are adjusted in response to changes in the input voltage VIN and the output voltage VOUT, such that the switching frequency FSW of the switched-mode power supply 10 is stabilized. This allows the inductor current ripple value to be calculated according to Formula (1).

FIG. 15 is a schematic structural diagram of a control circuit for a boost converter according to an embodiment of the present disclosure. Referring to FIG. 15, in a case where the switched-mode power supply is a boost converter, a first terminal of a first transistor Q1 serves as an output terminal of the switched-mode power supply. The first terminal of the first transistor Q1 is further electrically connected to a first terminal of an output capacitor Cout, and a second terminal of the output capacitor Cout is grounded (that is, connected to the GND terminal). A second terminal of the first transistor Q1 is electrically connected a first terminal of a first inductor L1 and a first terminal of a second transistor Q2 at a connection node SW. A second terminal of the first inductor L1 serves as an input terminal of the switched-mode power supply and is configured to receive an input voltage VIN. A second terminal of the second transistor Q2 is grounded (that is, connected to the GND terminal). A first terminal of a third resistor Rcot in a first timer circuit 26 is electrically connected the output terminal of the switched-mode power supply and is configured to receive the output voltage VOUT.

Using the boost converter as illustrated in FIG. 15 as an example, an embodiment provides a control circuit for the boost converter. Referring to FIG. 15, the control circuit includes a current sampling circuit 21, an inductor current ripple sampling circuit 22, a compensation current selection circuit 23, a current compensation circuit 24, a first resistor Ri, a second resistor Rsns, a first comparator COMP1, an inductor current sampling circuit 25, a first current output circuit 28, a first timer circuit 26, a second timer circuit 27, and a logic control circuit 20.

The circuit structures and technical effects of the current sampling circuit 21, the inductor current ripple sampling circuit 22, the compensation current selection circuit 23, the current compensation circuit 24, the first resistor Ri, the second resistor Rsns, the first comparator COMP1, and the inductor current sampling circuit 25 are the same as those in the above embodiments, which are not described herein any further. Different from the technical solution of the control circuit for the buck converter according to the above embodiments, in a case where the switched-mode power supply is a boost converter, the control circuit further includes a first current output circuit 28 electrically connected between the current sampling circuit 21 and the compensation current selection circuit 23. The first current output circuit 28 is configured to receive a loop compensation current Icmp, the input voltage VIN, and the output voltage VOUT, and generate a first current Imult based on the loop compensation current Icmp, the input voltage VIN, and the output voltage VOUT. The compensation current selection circuit 23 is further configured to, in a case where the switched-mode power supply is a boost converter, determine one with a greater current value between the first current Imult and a half-ripple control current Ipp1 as a target control current Ipp2.

In some embodiments, the first current output circuit 28 may be a logic calculation circuit. For example, in this embodiment, the first current output circuit 28 may specifically be a multiplier. A first input terminal A of the multiplier is configured to receive the loop compensation current Icmp, a second input terminal B of the multiplier is configured to receive the output voltage VOUT, a third input terminal C of the multiplier is configured to receive the input voltage VIN, and an output terminal of the multiplier is electrically connected to an input terminal of the compensation current selection circuit 23. The multiplier is configured to acquire a ratio by dividing a voltage value Vₒᵤₜ of the output voltage by a voltage value Vᵢₙ of the input voltage, and acquire a current value I_{Imult} of the first current by multiplying the ratio by a current value I_{Icmp} of the loop compensation current, i.e.,

$${I}_{Imult} = \frac{Vout \times {I}_{Icmp}}{Vin} .$$

The compensation current selection circuit 23 is further configured to, in a case where the switched-mode power supply is a boost converter, determine one with a greater current value between the first current Imult and the half-ripple control current Ipp1 as the target control current Ipp2.

In a case where the switched-mode power supply is a boost converter, the inductor current ripple sampling circuit 22 acquires the inductance value of the first inductor and the switching frequency of the switched-mode power supply, and calculates the inductor current ripple value of the switched-mode power supply according to Formula (6):

$$I p p = \frac{( Vout - Vin ) \times Vin}{Vout} \times \frac{1}{{L}_{L} \times Fsw} \times \frac{{R}_{Ri}}{{R}_{Rsns}} \qquad ( 6 )$$

The current value of half-ripple control current is that: Ipp1=0.5 lpp.

In Formula (6), Ipp represents the inductor current ripple value, Vin represents the voltage value of the input voltage of the switched-mode power supply, Vout represents the voltage value of the output voltage of the switched-mode power supply, L_{L} represents the inductance value of the first inductor, Fsw represents the switching frequency of the switched-mode power supply, R_{Ri} represents the resistance value of the first resistor, and R_{Rsns} represents the resistance value of the second resistor.

Different from the technical solution of the control circuit for the buck converter according to the above embodiments, in this embodiment, in a case where the switched-mode power supply is a boost converter, the first timer circuit 26 includes a second comparator COMP2, a third resistor Rcot, and a first capacitor Ccot. A first terminal of the third resistor Rcot is configured to receive the output voltage VOUT of the switched-mode power supply. A second terminal of the third resistor Rcot is electrically connected a first terminal of the first capacitor Ccot, and a second terminal of the first capacitor Ccot is grounded (that is, connected to the GND terminal). The first terminal of the first capacitor Ccot is further electrically connected to a non-inverting input terminal of the second comparator COMP2. The non-inverting input terminal of the second comparator COMP2 is configured to sample a voltage value of a third voltage at the first terminal of the first capacitor Ccot. An inverting input terminal of the second comparator COMP2 is configured to: receive a second difference value in a peak current control mode, wherein the second difference value is a voltage difference value between the voltage value of the output voltage VOUT and the voltage value of the input voltage VIN; or receive the input voltage VIN in a valley current control mode. The second comparator COMP2 is configured to compare the voltage value of the third voltage with the second difference value, and output a first clock signal in a case where the voltage value of the third voltage is equal to the second difference value, or compare the voltage value of the third voltage with the voltage value of the input voltage, and output the first clock signal in a case where the voltage value of the third voltage is equal to the voltage value of the input voltage. The logic control circuit 20 is configured to: in the peak current control mode, generate a first drive signal based on the first clock signal Tcot, wherein the first drive signal is configured to drive the first transistor Q1 to turn off; or in the valley current control mode, generate a second drive signal and a third drive signal based on the first clock signal Tcot, wherein the second drive signal is configured to drive the second transistor Q2 to turn off, and the third drive signal is configured to drive the first transistor Q1 to turn on.

Different from the technical solution of the control circuit for the buck converter according to the above embodiments, in this embodiment, in a case where the switched-mode power supply is a boost converter, the second timer circuit 27 according to this embodiment includes a second capacitor Cpfm, a fourth resistor Rpfm, and a third comparator COMP3. A first terminal of the second capacitor Cpfm is electrically connected the output terminal of the first current output circuit 28, and a second terminal of the second capacitor Cpfm is grounded (that is, connected to the GND terminal). The first terminal of the second capacitor Cpfm is further electrically connected to a non-inverting input terminal of the third comparator COMP3. A first terminal of the fourth resistor Rpfm is electrically connected the output terminal of the inductor current ripple sampling circuit 22, and a second terminal of the fourth resistor Rpfm is grounded (that is, connected to the GND terminal). The first terminal of the fourth resistor Rpfm is further electrically connected to an inverting input terminal of the third comparator COMP3. An output terminal of the third comparator COMP3 is electrically connected the logic control circuit 20. The non-inverting input terminal of the third comparator COMP3 is configured to sample a voltage value of a fourth voltage at the first terminal of the second capacitor Cpfm. The inverting input terminal of the third comparator COMP3 is configured to sample a voltage value of a fifth voltage on the fourth resistor Rpfm. The third comparator COMP3 is configured to compare the voltage value of the fourth voltage with the voltage value of the fifth voltage, and output a second clock signal Tpfm in a case where the voltage value of the fourth voltage is equal to the voltage value of the fifth voltage.

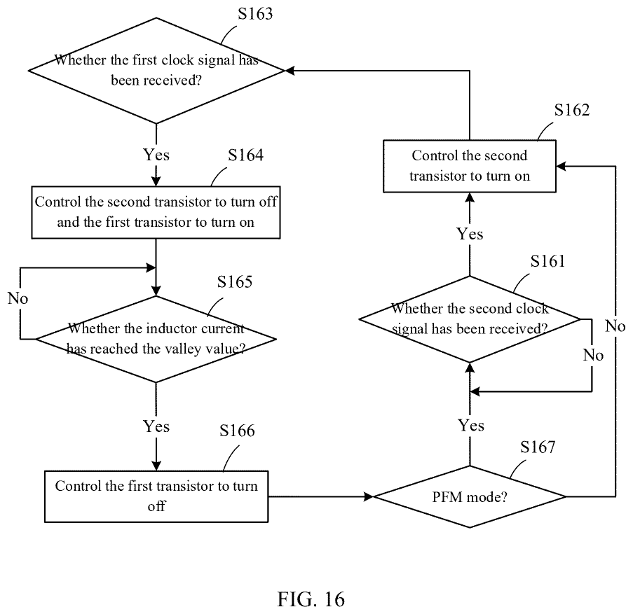

FIG. 16 is a flowchart of the operations of the logic control circuit for the boost converter in the constant on-time valley current control mode according to an embodiment of the present disclosure. The operating process of the logic control circuit is as follows:

In S161, in a case where the boost converter operates in the constant on-time valley current control mode, within a switching cycle, the logic control circuit first detects whether the second clock signal Tpfm has been received.

In a case where the second clock signal Tpfm has been received, the process proceeds to S162. In a case where the second clock signal Tpfm has not been received, S161 is repeated.

In S162, the logic control circuit controls the second transistor Q2 to turn on. The process then proceeds to S163.

In S163, the logic control circuit detects whether the first clock signal Tcot has been received. In a case where the first clock signal Tcot has been received, the process proceeds to S16.

In S164, the logic control circuit controls the second transistor Q2 to turn off and simultaneously controls the first transistor Q1 to turn on. The process then proceeds to S165.

In S165, the logic control circuit detects whether the inductor current has reached the valley value.

In a case where the inductor current has reached the valley value, the process proceeds to S166. In a case where the inductor current has not reached the valley value, S165 is repeated.

In S166, the logic control circuit controls the first transistor Q1 to turn off. The process then proceeds to S167.

In S167, after the first transistor Q1 is turned off, the logic control circuit determines whether the switched-mode power supply 10 operates in the PFM mode.

In a case where the switched-mode power supply 10 operates in the PFM mode, the process returns to S161 to determine whether the second clock signal Tpfm has been received. In a case where the switched-mode power supply 10 is not operating in the PFM mode, the process proceeds to S162 to control the second transistor Q2 to turn on.

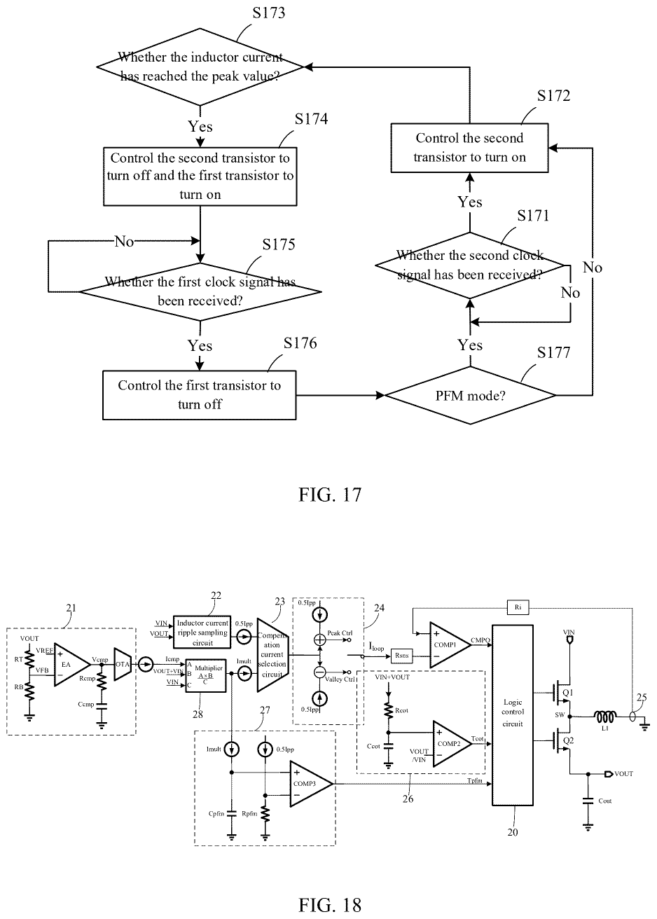

FIG. 17 is a flowchart of the operations of the logic control circuit for the boost converter in the constant off-time peak current mode according an embodiment of the present disclosure. The operating process of the logic control circuit is as follows:

In S171, in a case where the switched-mode power supply operates in the constant off-time peak current control mode, within a switching cycle, the logic control circuit first detects whether the second clock signal Tpfm has been received.

In a case where the second clock signal Tpfm has been received, the process proceeds to S172. In a case where the second clock signal Tpfm has not been received, S171 is repeated.

In S172, the logic control circuit controls the second transistor Q2 to turn on. The process then proceeds to S173

In S173, the logic control circuit detects whether the inductor current has reached the peak value. In a case where the inductor current has reached the peak value, the process proceeds to S174.

In S174, the logic control circuit controls the second transistor Q2 to turn off and controls the first transistor Q1 to turn on. The process then proceeds to S175.

In a case where the first control signal has been received, it is determined that the inductor current has reached the peak value.

In S175, the logic control circuit detects whether the first clock signal Tcot has been received.

In a case where the first clock signal Tcot has been received, the process proceeds to S176. In a case where the first clock signal Tcot has not been received, S175 is repeated.

In S176, the logic control circuit controls the first transistor Q1 to turn off. The process then proceeds to S177.

In S177, after the first transistor Q1 is turned off, the logic control circuit determines whether the boost converter operates in the PFM mode.

In a case where the boost converter operates in the PFM mode, the process returns to S171 to determine whether the second clock signal Tpfm has been received. In a case where the boost converter is not operating in the PFM mode, the process proceeds to S172 to control the second transistor Q2 to turn on.

It may be understood that, with the control circuit for the boost converter according to this embodiment, during control of the switched-mode power supply based on the loop control current Iloop, the switched-mode power supply may be enabled to adaptively adjust the output loop control current Iloop during mode switching, and further perform loop control on the switched-mode power supply based on the loop control current, such that the central value of the output voltage remains substantially consistent before and after the mode switching. This prevents the generation of large ripples in the output voltage and ensures the operational stability of the switched-mode power supply.

FIG. 18 is a schematic structural diagram of a control circuit for a buck-boost converter according to an embodiment of the present disclosure. Referring to FIG. 18, in a case where the switched-mode power supply is a buck-boost converter, a first terminal of a first transistor Q1 serves as an input terminal of the switched-mode power supply and is configured to receive an input voltage VIN. A second terminal of the first transistor Q1 is electrically connected a first terminal of a first inductor L1 and a first terminal of a second transistor Q2 at a connection node SW. A second terminal of the first inductor L1 is grounded (that is, connected to the GND terminal). A second terminal of the second transistor Q2 serves as an output terminal of the switched-mode power supply and is configured to output an output voltage VOUT. The second terminal of the second transistor Q2 is further electrically connected to a first terminal of an output capacitor Cout. A second terminal of the output capacitor Cout is grounded.

Using the buck-boost converter as illustrated in FIG. 18 as an example, an embodiment provides a control circuit for the buck-boost converter. Referring to FIG. 18, the control circuit includes a current sampling circuit 21, an inductor current ripple sampling circuit 22, a compensation current selection circuit 23, a current compensation circuit 24, a first resistor Ri, a second resistor Rsns, a first comparator COMP1, an inductor current sampling circuit 25, a first current output circuit 28, a first timer circuit 26, a second timer circuit 27, and a logic control circuit 20.

The circuit structures and technical effects of the current sampling circuit 21, the inductor current ripple sampling circuit 22, the compensation current selection circuit 23, the current compensation circuit 24, the first resistor Ri, the second resistor Rsns, the first comparator COMP1, and the inductor current sampling circuit 25 are the same as those in the above embodiments, which are not described herein any further. Different from the technical solution of the control circuit for the buck converter according to the above embodiments, in a case where the switched-mode power supply is a buck-boost converter, the control circuit further includes a first current output circuit 28. The first current output circuit 28 is configured to receive a loop compensation current Icmp, the input voltage VIN, and the output voltage VOUT, and generate a first current Imult based on the loop compensation current Icmp, the input voltage VIN, and the output voltage VOUT. The compensation current selection circuit 23 is further configured to, in a case where the switched-mode power supply is a buck-boost converter, determine one with a greater current value between the first current Imult and a half-ripple control current Ipp1 as a target control current Ipp2.

In some embodiments, the first current output circuit 28 may be a logic calculation circuit. For example, in this embodiment, the first current output circuit 28 may specifically be a multiplier. A first input terminal A of the multiplier is configured to receive the loop compensation current Icmp, a second input terminal B of the multiplier is configured to receive the input voltage VIN and the output voltage VOUT, a third input terminal C of the multiplier is configured to receive the input voltage VIN, and an output terminal of the multiplier is electrically connected to an input terminal of the compensation current selection circuit 23. The multiplier is configured to acquire a ratio by dividing a sum of the voltage value Vᵢₙ of the input voltage and the voltage value Vₒᵤₜ of the output voltage by the voltage value Vᵢₙ of the input voltage, and acquire a current value I_{Imult} of the first current by multiplying the ratio by a current value I_{Icmp} of the loop compensation current, i.e.,

$${I}_{Imult} = \frac{( Vin + Vout ) \times {I}_{Icmp}}{Vin} .$$

The compensation current selection circuit 23 is further configured to, in a case where the switched-mode power supply is a buck-boost converter, determine one with a greater current value between the first current Imult and the half-ripple control current Ipp1 as the target control current Ipp2.

Different from the technical solution for the control circuit for the buck converter according to the above embodiments, in this embodiment, in a case where the switched-mode power supply is a buck-boost converter, the first timer circuit 26 includes a second comparator COMP2, a third resistor Rcot, and a first capacitor Ccot. A first terminal of the third resistor Rcot is electrically connected to the input terminal and the output terminal of the switched-mode power supply and is configured to sample a voltage value of a sixth voltage, wherein the voltage value of the sixth voltage is a sum of the voltage value of the input voltage and the voltage value of the output voltage. A second terminal of the third resistor Rcot is electrically connected a first terminal of the first capacitor Ccot. A second terminal of the first capacitor Ccot is grounded (that is, connected to the GND terminal). The first terminal of the first capacitor Ccot is further electrically connected to a non-inverting input terminal of the second comparator COMP2. The non-inverting input terminal of the second comparator COMP2 is configured to sample a voltage value of a third voltage at the first terminal of the first capacitor Ccot. An inverting input terminal of the second comparator COMP2 is configured to receive the output voltage VOUT in a peak current control mode, or receive the input voltage VIN in a valley current control mode. The second comparator COMP2 is configured to compare the voltage value of the third voltage with the voltage value of the output voltage, and output a first clock signal Tcot in a case where the voltage value of the third voltage is equal to the voltage value of the output voltage, or compare the voltage value of the third voltage with the voltage value of the input voltage VIN, and output the first clock signal Tcot in a case where the voltage value of the third voltage is equal to the voltage value of the input voltage VIN.

Different from the technical solution of the control circuit for the buck converter according to the above embodiments, in this embodiment, in a case where the switched-mode power supply is a buck-boost converter, the second timer circuit 27 according to this embodiment includes a second capacitor Cpfm, a fourth resistor Rpfm, and a third comparator COMP3. A first terminal of the second capacitor Cpfm is electrically connected the output terminal of the first current output circuit 28, and a second terminal of the second capacitor Cpfm is grounded (that is, connected to the GND terminal). The first terminal of the second capacitor Cpfm is further electrically connected to a non-inverting input terminal of the third comparator COMP3. A first terminal of the fourth resistor Rpfm is electrically connected the output terminal of the inductor current ripple sampling circuit 22, and a second terminal of the fourth resistor Rpfm is grounded (that is, connected to the GND terminal). The first terminal of the fourth resistor Rpfm is further electrically connected to an inverting input terminal of the third comparator COMP3. An output terminal of the third comparator COMP3 is electrically connected the logic control circuit 20. The non-inverting input terminal of the third comparator COMP3 is configured to sample a voltage value of a fourth voltage at the first terminal of the second capacitor Cpfm. The inverting input terminal of the third comparator COMP3 is configured to sample a voltage value of a fifth voltage at the first terminal of the fourth resistor Rpfm. The third comparator COMP3 is configured to compare the voltage value of the fourth voltage with the voltage value of the fifth voltage, and output a second clock signal Tpfm in a case where the voltage value of the fourth voltage is equal to the voltage value of the fifth voltage.

The operating principle and operating process of the buck-boost converter of this embodiment may be understood with reference to the above embodiments, which are not described herein any further.

It may be understood that, with the control circuit for the buck-boost converter according to this embodiment, during control of the switched-mode power supply based on the loop control current Iloop, the switched-mode power supply may be enabled to adaptively adjust the output loop control current Iloop during mode switching, and further perform loop control on the switched-mode power supply based on the loop control current, such that the central value of the output voltage remains substantially consistent before and after the mode switching. This prevents the generation of large ripples in the output voltage and ensures the operational stability of the switched-mode power supply.

Based on the control circuit for the switched-mode power supply according to the above embodiments, an embodiment of the present disclosure further provides a chip. The chip includes the control circuit as described above.

It should be noted that the functions and technical effects of the chip according to this embodiment correspond to those of the control circuits in the above embodiments, which are not described herein any further.

Based on the control circuit for the switched-mode power supply according to the above embodiments, an embodiment of the present disclosure further provides an electronic device. The electronic device includes the control circuit as described above, or the chip as described above. The electronic device may specifically be a switched-mode power supply.

It should be noted that the functions and technical effects of the electronic device according to this embodiment correspond to those of the control circuit in the above embodiments, which are not described herein any further.

It should be finally noted that the above embodiments are used only for illustrating the present disclosure, but are not intended to limit the protection scope of the present disclosure. Various modifications and replacements readily derived by those skilled in the art within technical content of the present disclosure shall fall within the protection scope of the present disclosure. Therefore, the protection scope of the present disclosure is subject to the appended claims.

What is claimed is:

1. A control circuit for a switched-mode power supply, wherein the switched-mode power supply comprises a first transistor, a second transistor, and a first inductor; wherein the switched-mode power supply is a buck converter, a boost converter, or a buck-boost converter based on different connection relationships of the first transistor, the second transistor, and the first inductor; an input terminal of the switched-mode power supply is configured to receive an input voltage, and an output terminal of the switched-mode power supply is configured to output an output voltage; and the control circuit comprises a current sampling circuit, an inductor current ripple sampling circuit, a compensation current selection circuit, a current compensation circuit, a first resistor, a second resistor, a first comparator, an inductor current sampling circuit, and a logic control circuit; wherein
the current sampling circuit is configured to sample a voltage value of the output voltage at the output terminal of the switched-mode power supply, and acquire a current value of a loop compensation current based on the voltage value of the output voltage;
the inductor current ripple sampling circuit is configured to sample a voltage value of the input voltage and the voltage value of the output voltage, calculate an inductor current ripple value of the switched-mode power supply based on the voltage value of the input voltage and the voltage value of the output voltage, and generate a current value of a half-ripple control current based on the inductor current ripple value;
the compensation current selection circuit is configured to determine a target control current based on the loop compensation current and the half-ripple control current;
the current compensation circuit is configured to, in a case where the switched-mode power supply operates in a peak current control mode, add the current value of the half-ripple control current and a current value of the target control current to acquire a current value of a loop control current;
or in a case where the switched-mode power supply operates in a valley current control mode, acquire a current value of a loop control current based on a difference value between a current value of the target control current and the current value of the half-ripple control current;
the inductor current sampling circuit is configured to sample an inductor current in a branch where the first inductor is disposed, and transmit the inductor current to a non-inverting input terminal of the first comparator via the first resistor, wherein the inductor current passes through the first resistor to generate a first voltage;
the second resistor is configured to transmit the loop control current to an inverting input terminal of the first comparator, wherein the loop control current passes through the second resistor to generate a second voltage;
the first comparator is configured to compare a voltage value of the first voltage with the voltage value of the second voltage, and output a first control signal in a case where the voltage value of the first voltage is equal to the voltage value of the second voltage; and
the logic control circuit is configured to output a corresponding drive signal based on the first control signal, the drive signal being configured to drive the first transistor and/or the second transistor to turn on or turn off.

2. The control circuit according to claim 1, wherein in a case where the switched-mode power supply is a buck converter, the compensation current selection circuit is further configured to receive the loop compensation current output by the current sampling circuit, and determine one with a greater current value between the loop compensation current and the half-ripple control current as the target control current.

3. The control circuit according to claim 1, wherein in a case where the switched-mode power supply is a buck converter, an input terminal of the current sampling circuit is electrically connected to the output terminal of the switched-mode power supply, and an output terminal of the current sampling circuit is electrically connected to a first input terminal of the compensation current selection circuit; and two sampling terminals of the inductor current ripple sampling circuit are respectively electrically connected to the input terminal and the output terminal of the switched-mode power supply, and an output terminal of the inductor current ripple sampling circuit is electrically connected to a second input terminal of the compensation current selection circuit; and
an output terminal of the compensation current selection circuit is electrically connected to an input terminal of the current compensation circuit, and an output terminal of the current compensation circuit is electrically connected to the inverting input terminal of the first comparator via the second resistor; a sampling terminal of the inductor current sampling circuit is electrically connected to the branch where the first inductor is disposed, and an output terminal of the inductor current sampling circuit is electrically connected to the non-inverting input terminal of the first comparator via the first resistor; and an output terminal of the first comparator is electrically connected to a first input terminal of the logic control circuit, a first output terminal of the logic control circuit is electrically connected to a control electrode of the first transistor, and a second output terminal of the logic control circuit is electrically connected to a control electrode of the second transistor.

4. The control circuit according to claim 1, further comprising: a first timer circuit, wherein the first timer circuit comprises a second comparator, a third resistor, and a first capacitor; wherein
in a case where the switched-mode power supply is a buck converter: a first terminal of the third resistor is electrically connected to the input terminal of the switched-mode power supply, a second terminal of the third resistor is electrically connected to a first terminal of the first capacitor, a second terminal of the first capacitor is grounded, the first terminal of the first capacitor is further electrically connected to a non-inverting input terminal of the second comparator, and an output terminal of the second comparator is electrically connected to a second input terminal of the logic control circuit;
the non-inverting input terminal of the second comparator is configured to receive a voltage value of a third voltage at the first terminal of the first capacitor; the inverting input terminal of the second comparator is configured to receive the voltage value of the output voltage in the peak current control mode, or receive a first difference value in the valley current control mode, wherein the first difference value is a voltage difference value between the voltage value of the input voltage and the voltage value of the output voltage; and the second comparator is configured to compare the voltage value of the third voltage with the voltage value of the output voltage and output a first clock signal to the logic control circuit in a case where the voltage value of the third voltage is equal to the voltage value of the output voltage, or compare the voltage value of the third voltage with the first difference value and output the first clock signal to the logic control circuit in a case where the voltage value of the third voltage is equal to the first difference value; and
the logic control circuit is configured to, in the peak current control mode, generate a first drive signal based on the first clock signal, the first drive signal being configured to drive the second transistor to turn off; or in the valley current control mode, generate a second drive signal and a third drive signal based on the first clock signal, the second drive signal being configured to drive the first transistor to turn off, and the third drive signal being configured to drive the second transistor to turn on.

5. The control circuit according to claim 1, further comprising: a first timer circuit, wherein the first timer circuit comprises a second comparator, a multiplier, and a first capacitor; wherein
in a case where the switched-mode power supply is a buck converter: an input terminal of the multiplier serves as an input terminal of the first timer circuit and is configured to receive the voltage value of the input voltage of the switched-mode power supply, an output terminal of the multiplier is electrically connected to a first terminal of the first capacitor, a second terminal of the first capacitor is grounded, the first terminal of the first capacitor is further electrically connected to a non-inverting input terminal of the second comparator, and an output terminal of the second comparator is electrically connected to a second input terminal of the logic control circuit;
the multiplier is configured to multiply the voltage value of the input voltage by 1/R_{Rcot}, wherein R_{Rcot} is a resistance value of a third resistor;
the non-inverting input terminal of the second comparator is configured to obtain a voltage value of a third voltage at the first terminal of the first capacitor, and an inverting input terminal of the second comparator is configured to receive a reference voltage value; wherein in the peak current control mode, the reference voltage value is the voltage value of the output voltage of the switched-mode power supply; or in the valley current control mode, the reference voltage value is a first difference value, the first difference value being a voltage difference value between the voltage value of the input voltage and the voltage value of the output voltage of the switched-mode power supply;
the second comparator is configured to, in the peak current control mode, compare the voltage value of the third voltage with the voltage value of the output voltage of the switched-mode power supply and output a first clock signal in a case where the voltage value of the third voltage is equal to the voltage value of the output voltage; or in the valley current control mode, compare the voltage value of the third voltage with the first difference value and output the first clock signal in a case where the voltage value of the third voltage is equal to the first difference value; and
the logic control circuit is configured to, in the peak current control mode, generate a first drive signal based on the first clock signal, the first drive signal being configured to drive the second transistor to turn off; or in the valley current control mode, generate a second drive signal and a third drive signal based on the first clock signal, the second drive signal being configured to drive the first transistor to turn off, and the third drive signal being configured to drive the second transistor to turn on.

6. The control circuit according to claim 1, further comprising: a second timer circuit, wherein the second timer circuit comprises a second capacitor, a fourth resistor, and a third comparator; wherein
in a case where the switched-mode power supply is a buck converter: a first terminal of the second capacitor is electrically connected to the output terminal of the current sampling circuit, a second terminal of the second capacitor is grounded, and the first terminal of the second capacitor is further electrically connected to a non-inverting input terminal of the third comparator; and a first terminal of the fourth resistor is electrically connected to the output terminal of the inductor current ripple sampling circuit, a second terminal of the fourth resistor is grounded, the first terminal of the fourth resistor is further electrically connected to an inverting input terminal of the third comparator, and an output terminal of the third comparator is electrically connected to a third input terminal of the logic control circuit;
the non-inverting input terminal of the third comparator is configured to receive a voltage value of a fourth voltage at the first terminal of the second capacitor, the inverting input terminal of the third comparator is configured to receive a voltage value of a fifth voltage at the first terminal of the fourth resistor, and the third comparator is configured to compare the voltage value of the fourth voltage with the voltage value of the fifth voltage and output a second clock signal to the logic control circuit in a case where the voltage value of the fourth voltage is equal to the voltage value of the fifth voltage; and
the logic control circuit is configured to, in the peak current control mode or the valley current control mode, generate a fourth drive signal based on the second clock signal, the fourth drive signal being configured to drive the first transistor to turn on.

7. The control circuit according to claim 1, further comprising: a first timer circuit, wherein the first timer circuit comprises a second comparator, a third resistor, and a first capacitor; wherein
in a case where the switched-mode power supply is a boost converter: a first terminal of the third resistor is electrically connected the output terminal of the switched-mode power supply to receive the output voltage; a second terminal of the third resistor is electrically connected a first terminal of the first capacitor, a second terminal of the first capacitor is grounded, the first terminal of the first capacitor is further connected to a non-inverting input terminal of the second comparator, and an output terminal of the second comparator is electrically connected a second input terminal of the logic control circuit; the non-inverting input terminal of the second comparator is configured to receive a voltage value of a third voltage at the first terminal of the first capacitor; an inverting input terminal of the second comparator is configured to receive a second difference value in the peak current control mode, the second difference value being a voltage difference value between the voltage value of the output voltage and the voltage value of the input voltage, or the voltage value of the input voltage is received in the valley current control mode; the second comparator is configured to compare the voltage value of the third voltage with the second difference value and output a first clock signal in a case where the voltage value of the third voltage is equal to the second difference value, or compare the voltage value of the third voltage with the voltage value of the input voltage and output the first clock signal to the logic control circuit in a case where the voltage value of the third voltage is equal to the voltage value of the input voltage; and the logic control circuit is configured to, in the peak current control mode, generate a first drive signal based on the first clock signal, the first drive signal being configured to drive the first transistor to turn off; or in the valley current control mode, generate a second drive signal and a third drive signal based on the first clock signal, the second drive signal being configured to drive the second transistor to turn off, and the third drive signal being configured to drive the first transistor to turn on; or
in a case where the switched-mode power supply is a buck-boost converter, a first terminal of the third resistor is electrically connected to the input terminal and the output terminal of the switched-mode power supply to receive a voltage value of a sixth voltage, the voltage value of the sixth voltage being a sum of the voltage value of the input voltage and the voltage value of the output voltage; a second terminal of the third resistor is electrically connected to a first terminal of the first capacitor, a second terminal of the first capacitor is grounded, the first terminal of the first capacitor is further electrically connected to a non-inverting input terminal of the second comparator, and an output terminal of the second comparator is electrically connected to a second input terminal of the logic control circuit; the non-inverting input terminal of the second comparator is configured to receive a voltage value of a third voltage at the first terminal of the first capacitor; an inverting input terminal of the second comparator is configured to receive the voltage value of the output voltage in the peak current control mode or receive the voltage value of the input voltage in the valley current control mode; and the second comparator is configured to compare the voltage value of the third voltage with the voltage value of the output voltage and output a first clock signal to the logic control circuit in a case where the voltage value of the third voltage is equal to the voltage value of the output voltage, or compare the voltage value of the third voltage with the voltage value of the input voltage and output the first clock signal to the logic control circuit in a case where the voltage value of the third voltage is equal to the voltage value of the input voltage.

8. The control circuit according to claim 1, wherein in a case where the switched-mode power supply is a boost converter or a buck-boost converter: the control circuit further comprises a first current output circuit electrically connected between the current sampling circuit and the compensation current selection circuit, wherein the first current output circuit is configured to receive the loop compensation current, the input voltage, and the output voltage, generate a first current based on the loop compensation current, the input voltage, and the output voltage, and transmit the first current to the compensation current selection circuit; and
the compensation current selection circuit is further configured to receive the first current and the half-ripple control current, and determine one with a greater current value between the first current and the half-ripple control current as the target control current.

9. The control circuit according to claim 8, wherein in a case where the switched-mode power supply is a boost converter: an input terminal of the current sampling circuit is electrically connected to the output terminal of the switched-mode power supply, a first input terminal of the first current output circuit is electrically connected to an output terminal of the current sampling circuit, a second input terminal of the first current output circuit is electrically connected to the output terminal of the switched-mode power supply, a third input terminal of the first current output circuit is electrically connected to the input terminal of the switched-mode power supply, and an output terminal of the first current output circuit is electrically connected to a first input terminal of the compensation current selection circuit; and two sampling terminals of the inductor current ripple sampling circuit are respectively electrically connected to the input terminal and the output terminal of the switched-mode power supply, and an output terminal of the inductor current ripple sampling circuit is electrically connected to a second input terminal of the compensation current selection circuit; and
an output terminal of the compensation current selection circuit is electrically connected to an input terminal of the current compensation circuit, and an output terminal of the current compensation circuit is electrically connected to the inverting input terminal of the first comparator via the second resistor; a sampling terminal of the inductor current sampling circuit is electrically connected to the branch where the first inductor is disposed, and an output terminal of the inductor current sampling circuit is electrically connected to the non-inverting input terminal of the first comparator via the first resistor; and an output terminal of the first comparator is electrically connected to a first input terminal of the logic control circuit, a first output terminal of the logic control circuit is electrically connected to a control electrode of the first transistor, and a second output terminal of the logic control circuit is electrically connected to a control electrode of the second transistor.

10. The control circuit according to claim 9, wherein the first current output circuit is a multiplier, configured to acquire a ratio by dividing the voltage value of the output voltage by the voltage value of the input voltage, and acquire a current value of the first current by multiplying the ratio by a current value of the loop compensation current.

11. The control circuit according to claim 8, wherein in a case where the switched-mode power supply is a buck-boost converter: an input terminal of the current sampling circuit is electrically connected to the output terminal of the switched-mode power supply, a first input terminal of the first current output circuit is electrically connected to an output terminal of the current sampling circuit, a second input terminal of the first current output circuit is electrically connected to the input terminal and the output terminal of the switched-mode power supply, a third input terminal of the first current output circuit is electrically connected to the input terminal of the switched-mode power supply, and an output terminal of the first current output circuit is electrically connected to a first input terminal of the compensation current selection circuit; and two sampling terminals of the inductor current ripple sampling circuit are respectively electrically connected to the input terminal and the output terminal of the switched-mode power supply, and an output terminal of the inductor current ripple sampling circuit is electrically connected to a second input terminal of the compensation current selection circuit; and
an output terminal of the compensation current selection circuit is electrically connected to an input terminal of the current compensation circuit, and an output terminal of the current compensation circuit is electrically connected to the inverting input terminal of the first comparator via the second resistor; a sampling terminal of the inductor current sampling circuit is electrically connected to the branch where the first inductor is disposed, and an output terminal of the inductor current sampling circuit is electrically connected to the non-inverting input terminal of the first comparator via the first resistor; and an output terminal of the first comparator is electrically connected to a first input terminal of the logic control circuit, a first output terminal of the logic control circuit is electrically connected to a control electrode of the first transistor, and a second output terminal of the logic control circuit is electrically connected to a control electrode of the second transistor.

12. The control circuit according to claim 11, wherein the first current output circuit is a multiplier, configured to acquire a ratio by dividing a sum of the voltage value of the output voltage and the voltage value of the input voltage by the voltage value of the input voltage, and acquire a current value of the first current by multiplying the ratio by a current value of the loop compensation current.

13. The control circuit according to claim 8, further comprising: a second timer circuit, wherein the second timer circuit comprises a second capacitor, a fourth resistor, and a third comparator; wherein
a first terminal of the second capacitor is electrically connected to the output terminal of the first current output circuit, a second terminal of the second capacitor is grounded, and the first terminal of the second capacitor is electrically connected to a non-inverting input terminal of the third comparator; and a first terminal of the fourth resistor is electrically connected to the output terminal of the inductor current ripple sampling circuit, a second terminal of the fourth resistor is grounded, the first terminal of the fourth resistor is further electrically connected to an inverting input terminal of the third comparator, and an output terminal of the third comparator is electrically connected to a third input terminal of the logic control circuit; and
the non-inverting input terminal of the third comparator is configured to receive a voltage value of a fourth voltage on the second capacitor, the inverting input terminal of the third comparator is configured to receive a voltage value of a fifth voltage on the fourth resistor, and the third comparator is configured to compare the voltage value of the fourth voltage with the voltage value of the fifth voltage and output a second clock signal to the logic control circuit in a case where the voltage value of the fourth voltage is equal to the voltage value of the fifth voltage.

14. The control circuit according to claim 1, wherein the current sampling circuit comprises a voltage divider circuit, an error amplifier, and a transconductance amplifier; wherein
a sampling terminal of the voltage divider circuit is electrically connected to the output terminal of the switched-mode power supply, an output terminal of the voltage divider circuit is electrically connected an inverting input terminal of the error amplifier, and the voltage divider circuit is configured to divide the voltage value of the output voltage of the switched-mode power supply to acquire a voltage value of a first divided voltage; the inverting input terminal of the error amplifier is configured to receive the voltage value of the first divided voltage from the voltage divider circuit, and a non-inverting input terminal of the error amplifier is configured to receive a reference voltage value; and the error amplifier is configured to calculate an error voltage value between the voltage value of the first divided voltage and the reference voltage value, and amplify the error voltage value to acquire a voltage value of a loop compensation voltage; and
an output terminal of the error amplifier is electrically connected to an input terminal of the transconductance amplifier, and the transconductance amplifier is configured to generate the loop compensation current based on the loop compensation voltage.

15. The control circuit according to claim 14, wherein the voltage divider circuit comprises a fifth resistor and a sixth resistor; wherein a first terminal of the fifth resistor is the sampling terminal of the voltage divider circuit, a second terminal of the fifth resistor is electrically connected to a first terminal of the sixth resistor, and a second terminal of the sixth resistor is grounded, and the first terminal of the sixth resistor serves as the output terminal of the voltage divider circuit and is configured to output the first divided voltage.

16. The control circuit according to claim 14, wherein the current sampling circuit further comprises a seventh resistor and a third capacitor; wherein the output terminal of the error amplifier is electrically connected to a first terminal of the seventh resistor, a second terminal of the seventh resistor is electrically connected to a first terminal of the third capacitor, and a second terminal of the third capacitor is grounded.

17. The control circuit according to claim 1, wherein the current compensation circuit comprises an adder, a subtractor, and a selection switch; wherein two input terminals of the adder are respectively electrically connected to the output terminal of the inductor current ripple sampling circuit and an output terminal of the compensation current selection circuit, an output terminal of the adder is electrically connected to the selection switch, two input terminals of the subtractor are respectively electrically connected to the output terminal of the inductor current ripple sampling circuit and the output terminal of the compensation current selection circuit, and an output terminal of the subtractor is electrically connected to the selection switch;
the adder is configured to, in the peak current control mode, add the current value of the half-ripple control current and the current value of the target control current to acquire the current value of the loop control current, and generate the loop control current;
the subtractor is configured to, in the valley current control mode, subtract the current value of the half-ripple control current from the current value of the target control current to acquire the current value of the loop control current, and generate the loop control current; and
the selection switch is configured to, in the peak current control mode, select to be electrically connected to the output terminal of the adder to output the loop control current generated by the adder to the second resistor; or in the valley current control mode, select to be electrically connected to the output terminal of the subtractor to output the loop control current generated by the subtractor to the second resistor.

18. The control circuit according to claim 1, wherein the inductor current ripple sampling circuit is further configured to acquire an inductance value of the first inductor and a switching frequency of the switched-mode power supply; and
in a case where the switched-mode power supply is a buck converter, the inductor current ripple sampling circuit is further configured to calculate the inductor current ripple value of the switched-mode power supply according to the following formula:
$$I p p = \frac{( Vin - Vout ) \times Vout}{Vin} \times \frac{1}{{L}_{L} \times Fsw} \times \frac{{R}_{Ri}}{{R}_{Rsns}} ;$$
or
in a case where the switched-mode power supply is a boost converter, the inductor current ripple sampling circuit is further configured to calculate the inductor current ripple value of the switched-mode power supply according to the following formula:
$$I p p = \frac{( Vout - Vin ) \times Vin}{Vout} \times \frac{1}{{L}_{L} \times Fsw} \times \frac{{R}_{Ri}}{{R}_{Rsns}}$$
wherein Ipp represents the inductor current ripple value, Vin represents the voltage value of the input voltage of the switched-mode power supply, Vout represents the voltage value of the output voltage of the switched-mode power supply, L_{L} represents an inductance value of the first inductor, Fsw represents a switching frequency of the switched-mode power supply, R_{Ri} represents a resistance value of the first resistor, and R_{Rsns} represents a resistance value of the second resistor.

19. A control method for a switched-mode power supply, wherein the switched-mode power supply comprises a first transistor, a second transistor, and a first inductor; wherein the switched-mode power supply is a buck converter, a boost converter, or a buck-boost converter based on different connection relationships of the first transistor, the second transistor, and the first inductor; an input terminal of the switched-mode power supply is configured to receive an input voltage, and an output terminal of the switched-mode power supply is configured to output an output voltage; and the control circuit comprises a current sampling circuit, an inductor current ripple sampling circuit, a compensation current selection circuit, a current compensation circuit, a first resistor, a second resistor, a first comparator, an inductor current sampling circuit, and a logic control circuit;
wherein the method comprises:
sampling, by the current sampling circuit, a voltage value of the output voltage at the output terminal of the switched-mode power supply, and acquiring a current value of a loop compensation current based on the voltage value of the output voltage;
sampling, by the inductor current ripple sampling circuit, a voltage value of the input voltage and the voltage value of the output voltage, calculating an inductor current ripple value of the switched-mode power supply based on the voltage value of the input voltage and the voltage value of the output voltage, and generating a current value of a half-ripple control current based on the inductor current ripple value;
determining, by the compensation current selection circuit, a target control current based on the loop compensation current and the half-ripple control current;
in a case where the switched-mode power supply operates in a peak current control mode, adding, by the current compensation circuit, the current value of the half-ripple control current and a current value of the target control current to acquire a current value of a loop control current; or in a case where the switched-mode power supply operates in a valley current control mode, acquiring, by the current compensation circuit, a current value of a loop control current based on a difference value between a current value of the target control current and the current value of the half-ripple control current;
sampling, by the inductor current sampling circuit, an inductor current in a branch where the first inductor is disposed, and transmitting the inductor current to a non-inverting input terminal of the first comparator via the first resistor, wherein the inductor current passes through the first resistor to generate a first voltage;
transmitting, by the second resistor, the loop control current to an inverting input terminal of the first comparator, wherein the loop control current passes through the second resistor to generate a second voltage;
comparing, by the first comparator, a voltage value of the first voltage with the voltage value of the second voltage, and outputting a first control signal in a case where the voltage value of the first voltage is equal to the voltage value of the second voltage; and
outputting, by the logic control circuit, a corresponding drive signal based on the first control signal, the drive signal being configured to drive the first transistor and/or the second transistor to turn on or turn off.

20. A chip for a switched-mode power supply, wherein the switched-mode power supply comprises a first transistor, a second transistor, and a first inductor; wherein the switched-mode power supply is a buck converter, a boost converter, or a buck-boost converter based on different connection relationships of the first transistor, the second transistor, and the first inductor; an input terminal of the switched-mode power supply is configured to receive an input voltage, and an output terminal of the switched-mode power supply is configured to output an output voltage; and the chip comprises a current sampling circuit, an inductor current ripple sampling circuit, a compensation current selection circuit, a current compensation circuit, a first resistor, a second resistor, a first comparator, an inductor current sampling circuit, and a logic control circuit; wherein
the current sampling circuit is configured to sample a voltage value of the output voltage at the output terminal of the switched-mode power supply, and acquire a current value of a loop compensation current based on the voltage value of the output voltage;
the inductor current ripple sampling circuit is configured to sample a voltage value of the input voltage and the voltage value of the output voltage, calculate an inductor current ripple value of the switched-mode power supply based on the voltage value of the input voltage and the voltage value of the output voltage, and generate a current value of a half-ripple control current based on the inductor current ripple value;
the compensation current selection circuit is configured to determine a target control current based on the loop compensation current and the half-ripple control current;
the current compensation circuit is configured to, in a case where the switched-mode power supply operates in a peak current control mode, add the current value of the half-ripple control current and a current value of the target control current to acquire a current value of a loop control current; or in a case where the switched-mode power supply operates in a valley current control mode, acquire a current value of a loop control current based on a difference value between a current value of the target control current and the current value of the half-ripple control current;
the inductor current sampling circuit is configured to sample an inductor current in a branch where the first inductor is disposed, and transmit the inductor current to a non-inverting input terminal of the first comparator via the first resistor, wherein the inductor current passes through the first resistor to generate a first voltage;
the second resistor is configured to transmit the loop control current to an inverting input terminal of the first comparator, wherein the loop control current passes through the second resistor to generate a second voltage;
the first comparator is configured to compare a voltage value of the first voltage with the voltage value of the second voltage, and output a first control signal in a case where the voltage value of the first voltage is equal to the voltage value of the second voltage; and
the logic control circuit is configured to output a corresponding drive signal based on the first control signal, the drive signal being configured to drive the first transistor and/or the second transistor to turn on or turn off.
